(19) United States
(12) Patent Application Publication
(10) Pub. No.: US 2025/0145446 A1
(43) Pub. Date: May 8, 2025

(54) MODULAR OVERHEAD FUELING SYSTEM (OFS)

(71) Applicant: Exposure Illumination Architects, Inc., Scottsdale, AZ (US)

(72) Inventor: Daniel S. SPIRO, Scottsdale, AZ (US)

(73) Assignee: Exposure Illumination Architects, Inc., Scottsdale, AZ (US)

(21) Appl. No.: 18/937,230

(22) Filed: Nov. 5, 2024

Related U.S. Application Data
(60) Provisional application No. 63/547,599, filed on Nov. 7, 2023.

(51) Int. Cl. B67D 3/00; F17C 5/00; G06Q 20/42; G06Q 50/06

(52) U.S. Cl. CPC B67D 3/0003; F17C 5/007; G06Q 20/42; G06Q 50/06

(57) ABSTRACT

An overhead fueling system for a universal fuel source includes an overhead parking system module having programmable circuitry programmed to implement a parking manager communicatively coupled to a fuel charger. The parking manager includes a processor, resident memory and computer code that is executable by the processor, the programmable circuitry having a digital communication capability, wherein a fuel conductor conveys fuel from another conductor from an overhead remote source. The parking manager is configured to direct the fuel charger to convey fuel to a vehicle parked in the fueling parking stall by at least one of a fuel dispenser or an induction coil embedded in the fueling parking stall pavement.

### CROSS-REFERENCE TO RELATED APPLICATION

The present application claims the benefit of the earlier filing date of U.S. provisional patent application 63/547,599 filed on Nov. 7, 2023, the entire contents of which being incorporated herein by reference.

### BACKGROUND

### Technical Field

The present disclosure relates to systems controlled by a parking manager for fueling alternate fuel/s to vehicles in fueling parking stalls and lanes.

### Discussion of Background

While the world transitions to alternate vehicular fuel/s, the dimensions of vehicles and parking stalls are expected to remain unchanged. Consequently, designers of existing and new facilities look for solutions to build alternate fuel charging stations' infrastructure without sacrificing parking stalls and disrupting operation.

To maximize parking stalls' count, designers commonly design double loaded drive aisles with vehicles parked on opposite sides of the drive aisles. The module can repeat itself with the fronts of first drive aisle vehicles opposing vehicles' front ends parked in an adjacent second drive aisle. While this parking stall design configuration maximizes the parking stalls' count, it does not leave space for grade mounted fuel charging stations without sacrificing parking stalls.

Since the existing global inventory of parking stalls, at least in part, is expected to be fitted with alternate fuel charging stations, there is a growing need for a cost-effective solution to incorporate fuel charging stations into existing (and future) parking facilities occupying minimal space and causing minimal operational disruption. The optimal solution will avoid sacrificing parking stalls for the benefit of the new fuel charging stations and will minimize extensive trenching work for laying the new charging stations' infrastructure.

### SUMMARY

An overhead fueling system for a universal fuel source includes an overhead parking system module having programmable circuitry programmed to implement a parking manager communicatively coupled to a fuel charger. The parking manager includes a processor, resident memory and computer code that is executable by the processor, the programmable circuitry having a digital communication capability, wherein a fuel conductor conveys fuel from another conductor from an overhead remote source. The parking manager is configured to direct the fuel charger to convey fuel to a vehicle parked in the fueling parking stall by at least one of a fuel dispenser or an induction coil embedded in the fueling parking stall pavement

Aspects of the present disclosure includes:
a. The fuel charging station shall occupy no or minimal pavement area.
b. The fuel charging station shall not become a visual barrier at user's eye level.
c. The fuel charging station shall be able to provide various alternate fuel/s.
d. The fuel charging station interface/s for fueling and billing shall be user-friendly.
e. The fuel dispenser shall accommodate either side of a vehicle.
f. The fuel dispenser in at least one embodiment shall have a coupled interface.
g. The fuel dispenser in at least one embodiment shall have automated mobility.
h. The fuel charging system and/or its components shall be modular and/or scalable.
i. The fuel charging system shall be configured to receive power from below and/or above grade, or from overhead.
j. Laying the infrastructure of the fuel charging system shall require minimal trenching work.
k. The structure of the fuel charging system in at least one embodiment shall be able to support other structures and devices.
l. A parking manager shall govern at least one operation of the fuel charging system.
m. Sensing and/or charging device/s coupled to structure/s and/or to paved surface/s shall provide input/s to the parking manager.
n. The parking manager shall be configured to withstand environmental conditions throughout the life cycle of the facility.
o. The parking manager shall be configured to govern, in real time, all vehicular activities within a defined charging parking stall.

To meet the stated objectives, the present innovation employs an overhead structure system for fueling vehicles that operate on alternate fuel/s. The present innovation contains subject matter regarding the parking manager solution described in the Applicant's U.S. Pat. Nos. 10,653,014, 11,071,204 and U.S. application Ser. No. 17/334,722 now allowed patent, the entire contents of each of which are incorporated herein by reference in their entirety.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1a and 1b are plan views of head-to-head vehicular parking stalls before and after installing the OFS respectively.

FIGS. 2a, 2b, 2c and 2d are time-sequential elevations (side views) of an exemplary visual depiction of a step-by-step vehicular fuel charging process below an OFS module.

FIGS. 3a, 3b and 3c show an elevation, a transverse section, and a worm eye view respectively of an OFS with key elements concealed in a beam.

FIGS. 4a, 4b and 4c show an elevation, a transverse section, and a “worm eye view” respectively of an OFS with fuel charging devices coupled to the beam's exterior.

FIG. 5 is a transverse section through an OFS module with a double-sided canopy retaining photovoltaic panels and vehicles charged below the canopy.

FIG. 6 is a perspective view of an OFS module section of a continuous array with a double-sided canopy retaining photovoltaic panels and wireless charging induction coils embedded in the charging parking stalls' pavement below.

FIG. 7 is a perspective view of an OFS module section of a continuous array with a shading canopy structure that also retains photovoltaic panels and wireless charging induction coils embedded in the charging parking stalls' pavement below.

FIGS. 8a and 8b are plan and perspective views respectively partial vehicular head-to-head double sided parking stalls reconfigured as fueling drive lanes.

FIG. 9 is a diagram of a parking facility with fueling and non-fueling parking stalls located within an urban environment.

FIG. 10 is a diagram of an OFS' fueling parking manager's communication with managers corresponding to fueling, pole/s, streetlight/s, traffic and greater urban environment parking managers.

FIG. 11 is an interconnection diagram of devices and clients the OFS' parking manager is communicatively coupled to.

FIG. 12 is a flow chart of an exemplary process locating, navigating, and fueling a vehicle communicatively by a user and/or a vehicle with an option for pre-granted authorization to park and fuel a vehicle.

FIG. 13 is in a table of an array of devices that are communicatively coupled to the parking manager's processor with AI code processing input in unison, in real time and generating prioritized outputs.

FIG. 14 is a flow diagram for fueling a pre-authorized vehicle from entering to exiting a fueling parking stall.

FIG. 15 shows a process diagram for fueling a vehicle wherein the vehicle/user obtains fueling authorization through an interface parked in fueling parking stall.

FIG. 16 is a diagram of a computer based controller system used to perform processor-based control operations described herein.

FIG. 17 is a data extraction network that implements an AI engine according to one aspect of the present disclosure.

FIG. 18 is an exemplary concatenated source feature map for the AI engine according to one aspect of the present disclosure.

FIG. 19 is a supplemental feature map used by the AI engine.

### DETAILED DESCRIPTION

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

An aspect of the present disclosure is a modular Overhead Fueling System (OFS) governed by at least one parking manager. The system's base module can be configured to comprise at least one of each of: a post, a beam, a conduit, a coupler, a transformer, an interface, a panel, a switch, a fuel storage device, a fuel charger coupled to a fuel dispenser, and a parking manager.

This modular overhead fueling system is configured to be erected in existing and new parking facilities. The OFS can be erected in existing dimensionally regulated striped parking stalls without the need to alter the striping locations. In other words, existing parking stalls can be converted to fueling parking stalls without sacrificing a stall's regulated dimensions.

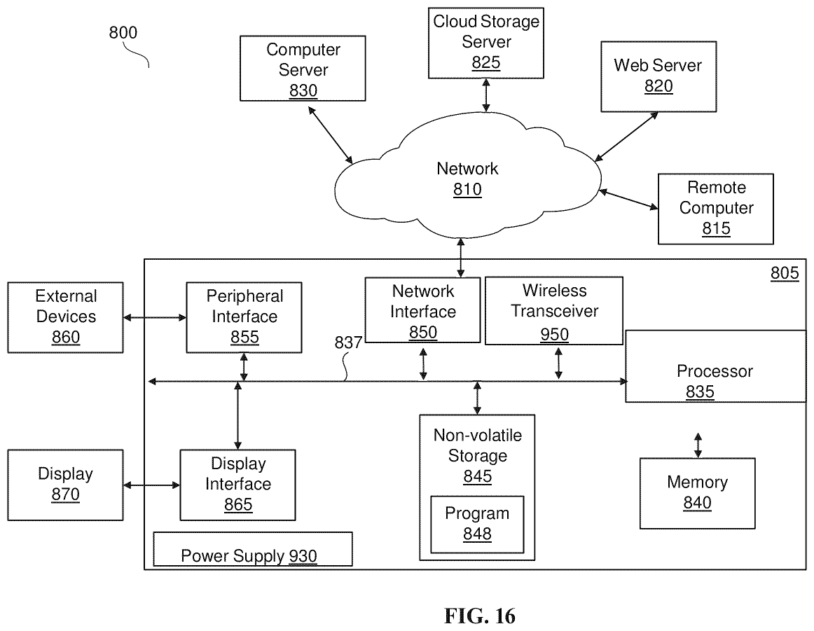

A parking manager, coupled to the OFS, is configured to have a processor (e.g., a programmable processor such as a microcontroller, computer, CPU, or multiple computers/processors interconnected via cabling, and/or wireless, such as a cloud computing network. Alternatively, or in addition to the programmable devices, hardwired devices or programmably hardwired devices such as ASICs and PALs may be used as well. This aspect of the disclosure will be discussed in more detail with respect to FIG. 16.). The parking manager's processor governs the operation of at least the OFS' coupled devices within a designated area of the OFS' domain. The domain can include at least one fueling parking stall.

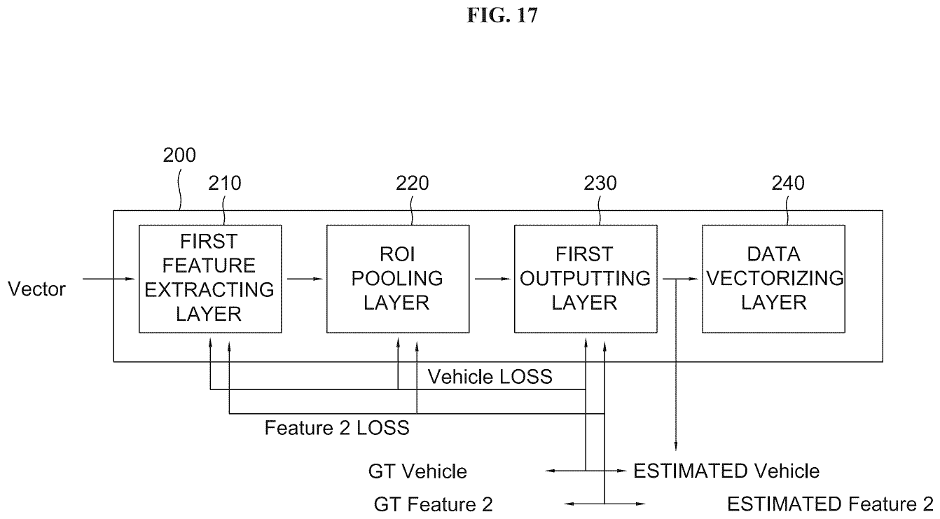

Code (e.g., computer readable instructions) executed by the processor is at least in part locally stored and can employ at least one AI algorithm, the AI engine(s) and training processes for which are discussed in more detail with respect to FIGS. 17-19. The parking manager can be coupled to at least one communication device and/or a sensing device. The parking manager can also be coupled to at least one of: a local fuel generation device, an air scrubbing device that removes pollutants, and at least one output device.

The OFS is modular, scalable, easy and quick to install, fabricated from sustainable material, and requires minimal area for its grade mounted elements. For retrofit work, the OFS requires minimal saw cutting of pavement, trenching, backfilling, and repaving work. The OFS is primarily suited for on-grade parking lots. However, the system can be adapted for use in covered parking structures supported by vertical structures. In both above referenced type of facilities, pavement mounted fueling equipment is undesirable.

The OFS fuel can be conveyed to an OFS module below grade and/or from overhead. At least one OFS module can retain a local fuel generating device. The local fuel generating device can include a photovoltaic panel and/or a wind turbine. In some embodiments, locally generated power can be sufficient to charge at least one vehicle parked within the fueling parking stall. Soon, efficient power generation and fuel storage devices coupled to the OFS will conceivably eliminate the need to be coupled to a remote fuel source.

The OFS can convey more than one fuel source. The more than one fuel source conveyed can fuel a vehicle or different vehicles parked within fueling parking stall/s. The fuel can be delivered to a vehicle from above and/or from grade level. In an embodiment one or more robotic arms governed by a parking manager provide an automated process for fueling vehicles by controllably inserting or attaching a duel dispenser to the vehicle's fuel receptacle(s).

The basic OFS module includes at least one support post and a horizontal beam that is coupled from above. The beam can cantilever from a post. The module can be stand-alone or configured to form an array. The array can have the same or different spacing between the posts. The arrayed configuration is cost beneficial, by having a single fuel source point of access to the array's continuous beam. The fuel received from a remote source can enter the beam's point of access from an overhead location and/or from below through a conduit coupled and/or in proximity to a post.

The OFS module in general and, the OFS' beam specifically, can be configured to convey at least one of: electric fuel (e.g., provided as an electric current that charges a battery), liquid fuel (e.g., gas or diesel fuel), gas fuel (e.g., hydrogen in gas or liquid form), and/or photonics fuel (e.g., high intensity light from a light source). It is recognized that some vehicles operate off of more than one type of fuel, and have more than one receptacle for receiving fuel. For example, plug-in hybrid vehicles receive both electricity and gasoline, and use both sources of stored energy for fueling the vehicle's drive system. The OFS described herein is equipped with different kinds of fuel dispensers, each with a different kind of connector (e.g., nozzle for gas/diesel, connector for electricity, gas fitting for hydrogen, and panel collector for light collection). In at least one embodiment, a combination of fuels can be conveyed by an OFS' beam. Further, the combination of fuels can be conveyed to a single vehicle from above, from below, or in a combination thereof. In one embodiment OFS includes a motor driven trolly that rides along the beam, where the trolly carries a series of dispenser hoses/cables for each type of fuel. After the type of fuel is detected, and then requested by the processor for dispensing to the vehicle, the trolly deploys the selected hose/cable (or both in the case of a plug-in hybrid vehicle) via a motor-driven reel on which the dispenser is wrapped. For lateral positioning, the motor driven trolly controllably moves the dispenser hoses/cables to be over the side of the vehicle that has the fuel receptacle. For horizontal positioning the OFS provides navigation instructions to the vehicle so the vehicle pulls into the stall at a depth that horizontally aligns the fuel receptacle with the trolly. For vertical positioning, the processor controls deployment of the hose/cable(s) to within arm's reach of an attendant and/or robotic arm to attach the selected hose/cable to the matching fuel receptacle for the vehicle.

It should further be noted that with respect to charging an electric vehicle, including a hybrid vehicle, the charging power may be conveyed via a magnetic field from a charging coil(s) located under the vehicle to a pickup coil(s) hosted on the vehicle. The structure of this arrangement is described in more detail in U.S. application Ser. No. 17/334,722.

In at least one embodiment, the basic module can be configured to structurally support a secondary system such as a shading device canopy. The shading device cover and/or the OFS' beam can include at least one of: a photovoltaic panel/s and/or an air scrubbing device. The air scrubbing devices can remove harmful particulates from the air. These devices can also be configured to operate in conjunction with fuel generating devices such as wind turbines.

On-grade large parking lots are common to airports, stadiums, educational facilities, and manufacturing facilities. It is safe to predict that future parking facilities and in particular on-grade parking lots will be fitted with alternate fuel charging devices. It is also self-evident that on-grade parking facilities are well suited to employ fuel generating devices with or without an air scrubbing device that removes pollutants.

The present innovation addresses the present need for alternative fueling devices. It does so by incorporating technology to structure, retaining existing parking stalls' regulatory dimensions, minimizing visual obstruction, without sacrificing existing parking stalls, minimizing pavement penetration work, facilitating serviceability for dispensing a plurality of fuel sources, and enabling easy and friendly human and machine interaction in a safe environment.

Further, the costs of the present innovation's erection and operation are anticipated to be significantly less than other available fuel dispensing products.

### Aspects of The OFS

The Post—The post is a vertical structure configured to support at least one beam. The post profile dimensions can be minimal, thus occupying a minimum pavement area. The transverse cross-section area of the posts can be sufficiently small to suit the erection of an overhead parking system module over existing and/or new dimensionally regulated parking stall/s without sacrificing a regulated dimension of a stall.

The post height is configured to be well above the height of a vehicle type to be parked in a fueling parking stall below. The post can couple the beam from below and/or from the side. In a different embodiment, the post can extend above the beam, with at least one through opening to allow the passage of at least one fuel conduit through.

The typical post height of the OFS module varies between eight and twelve feet above finished grade for sedan-type vehicles. For trucks and other high-profile vehicles, the post height can extend up to twenty feet above finished grade. It is also noted that the dimensions of the fueling parking stall correspond to the fueled vehicle type.

The post profile can be tubular or non-tubular, can be made of metallic or non-metallic material, can be fire-resistant, corrosion-resistant, and sufficiently strong to support its weight and all above installed loads under the harshest environmental conditions. The post can be coupled to the pavement, embedded in the ground or coupled to a foundation.

The post can be protected from direct impact by a protective guard. Such a protective guard can extend 24″-48″ from the pavement upwardly. In addition, at least one fuel conduit can couple to the post and/or disposed in the proximity to the post. In at least one embodiment, the fuel conduit can be configured to rise from below the pavement and couple to a horizontally oriented fuel conduit that is coupled to the beam above.

The post can also provide a structural support to a coupled display panel interface. The display panel can facilitate at least one transaction between a user and the parking manager. This transaction can include obtaining financial authorization to fuel a vehicle. The display panel can communicate with the parking manager and/or a remote processor by wire or wirelessly. The display panel can operate on low voltage and couple to the post at approximately 42″ above grade from one or both sides of the post.

The Beam—The beam spans between two posts and is coupled from at least one support post from above. The beam supports its weight and the weight of all other coupled devices and accessories. The devices and accessories can be coupled to the beam's interior and/or exterior surfaces. The bottom of the beam is typically mounted no less than eight feet above finished grade. The beam contains a portion of or all the devices necessary to fuel at least one vehicle parked in a fueling parking stall below the OFS.

The devices coupled to the beam can include at least one of: a fuel charger coupled to a cable with a fuel dispenser, a fuel conduit, a transformer, an inverter/rectifier, a fuel storage device, a breaker panel, a switch, a display panel, an audio device, a sign, a light source, a signaling device, and a parking manager that can couple to at least one of: a communication device and/or a sensing device. As discussed above the beam can support a motorized trolly of different fuel dispensers that are individually deployable based on the type of fuel used for the vehicle. The parking manager can include a processor with resident memory and code. The parking manager code can include at least one AI algorithm.

The beam can have several profiles including an “I” profile, an “O” profile, and an upside down “U” shaped profile. The latter can be a preferred profile by protecting internal coupled devices from the elements from three sides. The beam can be made solely or partially of metallic material such as steel/aluminum, and/or non-metallic material such as fiberglass.

The depth of the beam is dictated by the physical height, volume, weight the coupled devices impose on the beam, and environmental conditions the beam design is configured to factor. The beam can be configured to receive paint and graphics, whereas metallic beams can also be galvanized or anodized.

The Fueling Parking Stall—The fueling parking stall is typically delineated with three stripes defining the stall's boundaries. The stall's fourth boundary, not typically shown with a stripe, abuts a drive aisle. Through the latter boundary a vehicle enters the stall. The striping also establishes a proximity relationship between the stall location and the location of at least one fuel dispenser.

It is noted that the minimum dimensions of a parking stall are regulated by local jurisdiction construction code and land value is costly. Therefore, to optimize cost benefit, most existing and future parking lots stalls' striping relies on the minimal stall dimension allowed by the governing jurisdiction. The present innovation's variable beam span is configured in relation to the width of a stall/s where it will be erected, and the number of stalls existing/designed between the beam's support posts.

In addition, the present innovation can employ at least one of: a pavement embedded EV charging induction coil, a sensing device, and/or a communication device. The devices can be embedded apart from one another, and/or at least two devices can be coupled to a unitary housing. Such an arrangement is described in U.S. patent application Ser. No. 17/334,722, the entire contents of which is incorporated herein by reference.

The Fuel Dispenser—The fuel dispenser coupled to the fuel charger by a cable is suspended from the beam. At its resting position (the first station), the fuel dispenser can be aligned with the driver side of the vehicle. The present innovation foresees a range of processes needed in fueling a vehicle. These processes can vary from manual by having a user interact with a machine to semi-automated, or fully automated processes carried out by machines.

Regardless of the nature of the process, it is understood that a vehicle fuel receptacle can be located at either side of the vehicle or between both sides. Therefore, the present innovation fuel dispenser can reach any vehicle fuel receptacle parked below and within the striped boundaries of the parking stall.

The OFS's parking manager can provide several interactive means to fuel a vehicle that is parked in a charging parking stall. These interactive means employ processes that can be executed by a user and/or a machine. Among these means of interaction, the present innovation can include an interface coupled to a dispenser's fuel plug.

By having an interface coupled to a dispenser's fuel plug, a user can easily obtain permission to at least fuel a vehicle by holding the fuel plug in proximity to a personal authenticator, swiping a card, and/or entering input into a display. In another embodiment, the authenticator can be worn by the user such as a bracelet and the interface can be taught to recognize the user by at least one non-interactive means of authentication.

The fuel dispenser of the OFS can fuel at least one specific fuel source type or can be configured to fuel more than one fuel source type. Further, in at least one embodiment, the fuel dispenser can provide a mix of fuel source types. The fuel dispensed, alone or mixed, can be modulated by at least flow rate and intensity.

Since there are several emerging technologies for fueling vehicles, it is difficult to predict which technology will become the industry's standard. Regardless, the OFS infrastructure is universal and anticipates at least two fuel sources becoming commonplace. Therefore, the present innovation's infrastructure is adaptable and configured to accommodate at least two fuel types of fuel sources.

Managing Vehicle Fueling—The parking manager can manage parking stalls within an OFS module, and/or can manage an entire array comprising a plurality of OFS modules coupled. The parking manager, in communication with neighboring parking managers, can manage an entire or a portion of a fueling parking facility with or without ordinary parking stalls.

While the OFS innovation focuses on fueling vehicles inside fueling parking stalls, the parking manager can provide several functionalities well before a vehicle enters a fueling parking stall. These functionalities can include finding a fueling location, assisting a vehicle/user navigating the vehicle to the fueling location, and within the fueling location navigating the vehicle/user to a vacant fueling parking stall.

The parking manager can be configured to communicatively couple to the vehicle and/or a device in possession of a user inside or outside the vehicle. The communication capability can enable the parking manager to at least:

Identify the Vehicle Identification Number (VIN) and/or the vehicle's specifications pertinent to at least one of: identifying the fuel type needed, the charging cycle needed, the charging load recommended, and the location of the fuel receptacle and/or induction coil.

Identify and/or associate the party financially responsible for fueling the vehicle.

Interact with the vehicle's processors and/or with a user inside the vehicle.

Link the vehicle and/or user to a membership or a service subscription.

Most importantly, the communication capability can make the fueling process efficient by either eliminating the need for a user to exit a vehicle (wireless charging for example) or limit the user activity to only placing the fuel dispenser in the vehicle's fuel receptacle.

Further, where pavement embedded wireless chargers exist, the parking manager can be communicatively coupled to a vehicle and/or a user, to navigate the vehicle to an optimal charging location below the vehicle.

The parking manager gives permission to a vehicle/user to enter a charging parking stall. Communicating with the vehicle and/or the user and/or the sensing device, the parking manager determines the location of the vehicle's fuel receptacle. Then, the parking manager can direct the fuel dispenser to travel laterally to the side where the vehicle's fuel receptacle is located. Next, the parking manager can direct the fuel dispenser be lowered to a user's arm height. From there, a user can pull the fuel dispenser and plug it into the vehicle's fuel receptacle. Upon completing the fueling cycle, the fuel dispenser can retract to its first station.

Where the vehicle and/or the user have no means to interact with the parking manager from within the vehicle, an interactive panel located on the post and/or in the vicinity of the post can enable user communication with the parking manager to facilitate at least one transaction, including fueling authorization.

The charging parking stall is a dedicated parking zone for charging vehicles. The zone is configured to be controlled by a parking manager that observes the activity within at least one charging parking stall in real time. The parking manager can grant a vehicle permission to enter a charging stall, process financial transaction/s, enable fueling a vehicle, and report anomalies that can include threats to humans and property.

AI Code—As will be discussed in greater detail with respect to FIGS. 17-19, the parking manager processor's code can employ AI algorithms (often referred to as an “AI engine”, which may be implemented as one or more trained convolutional neural networks, or other structures such as a graph neural network(s)) that can include predictive and self-learning algorithms. A beneficial learning algorithm the AI code implements is learning machine and human behavior inside at least one fueling parking stall. It can also learn overlapping machine and human behavior in at least one surrounding fueling parking stall and/or driveway. For this, base reference information (sometimes referred to as “ground truth”) is needed.

To obtain this information, a sensing device such as the parking manager's camera can establish a digital base reference map of its domain. The domain can include one or several fueling parking stall/s. Within the domain's boundary/ies the image map can establish a record of the optimal domain imagery under various environmental conditions. Information included with the base reference can include the fueling parking stall location within the greater parking facility and the parking facility location within the greater geographical area.

The referenced base information can then be evaluated by the processor's AI code, in real time or periodically, to determine whether any changes within the domain present a threat to humans, animals and/or property.

The AI code can be taught (by applying a series of images to the CNN, as will be discussed, and backpropagating losses based on comparison estimates to ground truths) at least one of:

The location and functionality of each sensing, input, and output device within the fueling parking stall and remote parking manager and/or associated device

Size, color, shape, and specifications of all moving objects capable of being fueled

Recognition of specific formats of alphanumeric characters and/or symbols

Recognition of changes in the environment due to seasonal changes such as icing, ponding, leaf scattering and other debris

Recognition of humans and animals by form and body language

Recognition of sound including human voice recognition and ability to interact vocally

Ability to improve on friendly interaction with a vehicle processor, handheld device, and an exterior mounted interface through at least a feed-back loop

Recognition of threats to humans, animals, and/or property

The latter feature is of utmost importance as the environment in and around the fueling parking stall includes moving humans and vehicles at different speeds, possible moving objects like shopping carts, and fuel charging systems that are not the same for all vehicles.

For example, a user may opt to smoke next to a hydrogen fuel dispenser. A parking manager sensor can recognize the smoker and the parking manager can then immediately stop the vehicle's fueling. Similarly, an EV user decides to fuel his/her vehicle while running the engine. The parking manager prompted by a sensor input then immediately stops the fueling. The parking manager can then transmit and/or display a message to the user to turn off the engine as a condition to fuel the vehicle.

The present innovation configures that higher-level algorithms can aggregate multiple domain specific inputs over time. Then, in real time, the AI engine (as discussed with respect to FIGS. 17-19) is trained to discern and decide in prioritized order the output needed to deliver optimal results. The action may be preemptive in anticipation for a predictable outcome, and/or reactive following a human, an animal and/or a machine triggering such a reaction.

The higher-level machine thinking includes teaching the machine the base reference information, and then establishing guidelines and developing pointed logic that refines the code's ability to better service users. The means self-refining can include feedback loops for machine learning including interacting with users for feedback. Furthermore, in some networked embodiments, communicatively coupled parking managers can learn from one another's experience and can preempt predictable outcomes and/or react collectively when needed.

Forward Looking Coupled Technologies (not shown)—The present innovation teaches and shows a means to fuel vehicles from a pavement surface and from an overhead structure. The overhead structure can employ an overhang that can extend a portion of or the full length of a parking stall below. Both the pavement and the overhead structures of the present innovation can retain infrastructure that can be configured to fuel vehicles.

As soon as the vehicle industry develops standards for vehicular fuel receptacles to be coupled to robotic arms, it is conceivable that the fueling process will become automated wherein a robotic arm emerges from the pavement and/or from an overhead structure and fuels a vehicle. While this robotic arm solution is not shown, it is anticipated to emerge within this decade.

As an upgrade to an existing parking facility or for new facility, the code operating the parking manager can be configured to also operate a robotic arm. The code will include at least one of: a safety protocol to protect humans, animals, and objects, stationary and mobile, from contacting a fueling robotic arm.

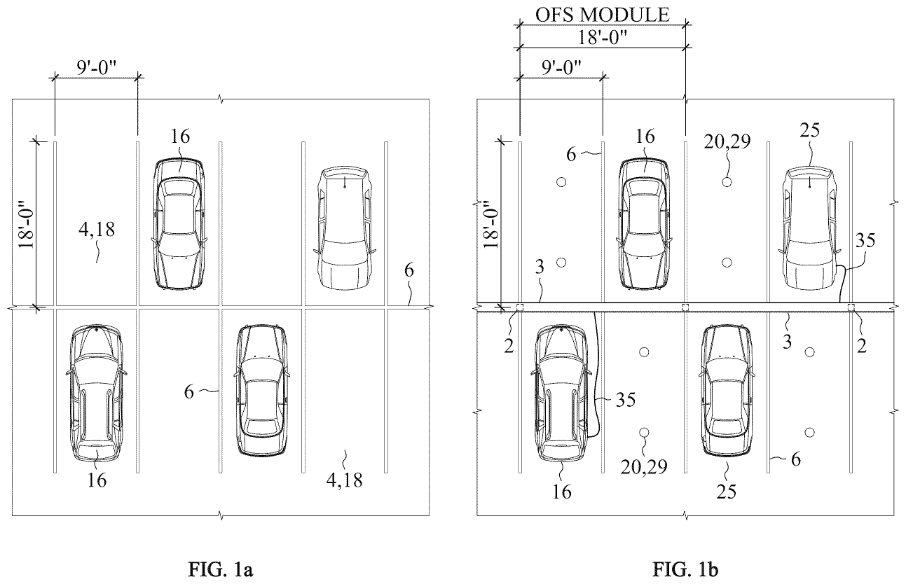

FIGS. 1a and 1b show plan views of head-to-head vehicular parking stalls before and after installing the OFS respectively.

FIG. 1a shows an array of common head-to-head parking stall 18 striping 6. A vehicle 16 enters the paved 4 stall 18 through an un-striped side of the parking stall 18. This common parking stall 18 configuration can be adapted to provide more than one type of fuel 20.

In the US the width and length of the parking stalls 18 is governed by the building code of the local jurisdiction. The minimal parking stall 18 width and length limits can be as narrow as 8′-6″ and as short length as 18′-0″.

The parking stall 18 configuration can be perpendicular to the stripe 6 in front of a vehicle 16 or angled. Angled parking stalls 18 are typically associated with single direction vehicular traffic. A double loaded drive aisle (not shown) with angled parking stalls can be narrower than bi-directional double loaded drive aisles with perpendicularly configured parking stalls 18.

FIG. 1b shows the same head-to-head parking stalls' striped 6 configuration with an OFS module beam 3 supported from below by posts 2. On the fueling parking stalls' 25 pavement's 4 surface, a plurality of fuel 20 induction coils 29 shown can fuel from below EV's by means of inducing electrical fuel 20 wirelessly. It is noted that the parking stall 18 as shown, can easily be configured to become a fueling parking stall 25.

The present figure shows several vehicles 16 parked in fueling parking stalls 25. Two of the vehicles 16 are shown receiving fuel 20 through coupled fuel dispensers 35. The other two vehicles 16 are shown receiving fuel 20 by means of wireless induction. Induction coils 29 embedded in the pavement 4 transmit electrical power to reciprocating coils 49 (not shown) coupled to the vehicle's 16 bottom side (see Applicant's U.S. application Ser. No. 17/334,722 now allowed patent for more detail).

As shown, the OFS' post 2 footprint occupies minimal pavement 4 area. This area is commonly striped 6. Consequently, the OFS module 1 posts' 2 locations satisfy several innovation objectives by being aligned with and above the stripes' 6 intersection—the location where the defined space of one fueling parking stall 25 abuts the defined space of a head-to-head fueling parking stall 25 and/or a side defined space of adjacent side fueling parking stall 25.

The objectives satisfied by the OFS module 1 placement include minimal occupancy of pavement 4 area, no fueling parking stalls 25 sacrificed for the benefit of making space for fueling devices, and no pavement 4 mounted fueling devices that obstruct visibility and pose a safety risk.

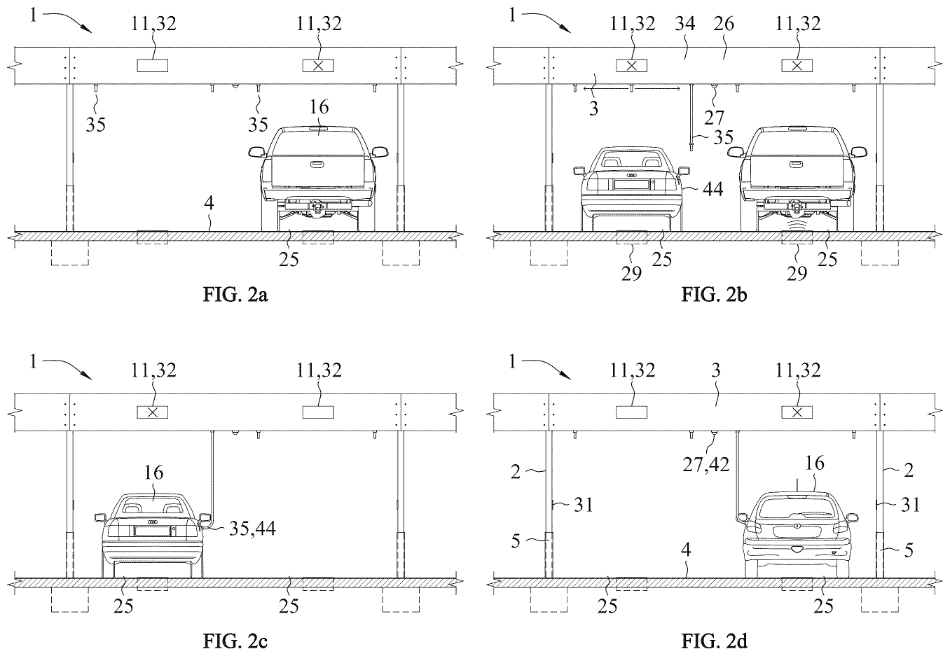

FIGS. 2a, 2b, 2c and 2d elevations show an exemplary depiction of a step-by-step vehicular fuel charging process below an OFS module.

The present innovation foresees four basic process steps in fueling a vehicle 16 from the point when a user and/or a machine decides to fuel a vehicle 16. As onboard devices, means of communication, and OFS 1 devices become more advanced, at least one of the steps can be automated, reducing the number of steps.

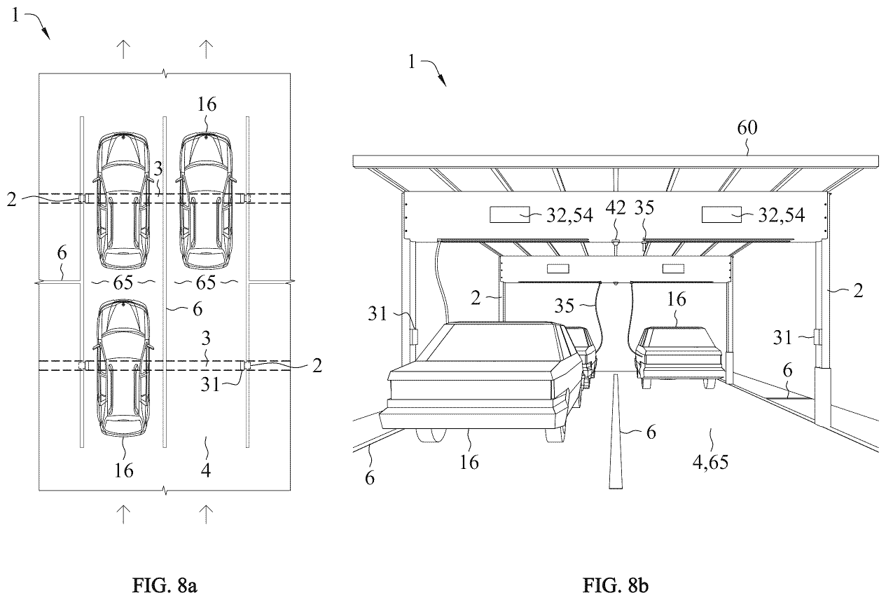

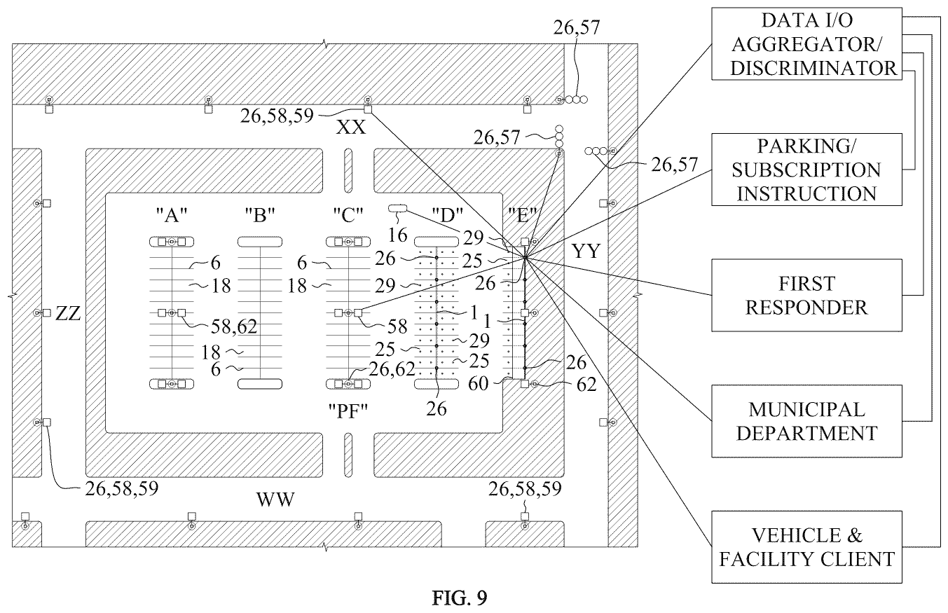

The basic steps include identification of a fueling station location, navigation to a selected fueling station location, obtaining access authorization to enter a fueling parking stall 25, and transacting by at least fueling a vehicle 16. FIGS. 8 and 9 show exemplary flow diagrams corresponding to manual and automated decisions the parking manager 26, a driver (user), a vehicle's 16 processor 50, and/or a portable device 51 makes throughout the fueling process.

FIGS. 2a-d focus only on one exemplary scenario from when a vehicle 16 arrives at an OFS module 1 to when the vehicle 16 vacates the OFS module 1. The figures show two means of fueling vehicles 16 by an OFS module 1: one means from an overhead fuel dispenser 35, and the other from a pavement 4 embedded induction coil 29.

A parking manager 26 coupled to an elevated structure can manage the parking and fueling operations within the fueling parking stalls 25. The parking manager's 26 processor 50 can communicatively couple to at least one of: a sensing device 27, a communication device 28, and a charging device 34.

The mobile overhead fuel dispenser 35 can have at least two stations. The present figures show three stations including: the first station (default position), the second station showing the fuel dispenser's 35 vertical and/or lateral movement to adapt its location to the parked vehicle 16 fuel receptacle 44 location, and the third station showing the fuel dispenser 35 engaged inside the vehicle's 16 fuel receptacle 44.

FIG. 2a shows an elevation of the OFS 1 fueling module with one vehicle 16 occupying a fueling parking stall 25 on the right side, and the left side fueling parking stall 25 is shown vacant. The overhead sign 11, 32 coupled to the beam 3 above the vehicle 16 can show in alphanumeric and/or in illuminated color and/or symbol no entry to the stall 25 throughout the duration the vehicle 16 is parked within. Conversely, the sign 11, 32 above the vacant fueling parking stall 25 can show the vacancy, inviting a vehicle 16 to enter.

The present figure shows the fuel dispensers 35 of both fueling parking stalls 25 on the driver side of the vehicle 16. The driver side of the vehicle 16 can be the first station for a laterally mobile overhead fuel dispenser 35. In alternate configurations, the first station can be anywhere within the width of the fueling parking stall 25.

FIG. 2b shows an elevation of the OFS module 1 with two vehicles 16 occupying the fueling parking stalls 25. The signs 11, 32 coupled to the beam 3 above indicate no entry to the occupied stalls 25. The vehicle 16 shown on the right is shown fueled 20 by an induction coil 29 embedded in the pavement 4. The vehicle 16 shown on the left is ready to be fueled by an overhead fuel dispenser 35 coupled to a concealed charger device 34 supported by the overhead beam 3.

The fuel dispenser 35 in the present figure extends down to arm's height at the opposite side of the driver side. In one embodiment, this location can be referred to as the second station. Getting to the second station may require obtaining fueling authorization first. Upon obtaining authorization, the parking manager 26 (concealed inside the beam in this figure) can direct a pully to lower the fuel dispenser 35 to a user's arm's height. With manually operated fuel dispensers 35, the user can pull the fuel dispenser 35 laterally before pulling the fuel dispenser 35 toward the fuel receptacle 44 of the vehicle 16.

In yet another embodiment, the parking manager's 26 processor 50 is aware of the vehicle's 16 right side fuel receptacle 44. After obtaining financial authorization to fuel the vehicle, the parking manager 26 can autonomously move the fuel dispenser 35 laterally to the right side and then lower it. For an autonomous process, this stage can be referred to as the second station. In yet a different embodiment, the fuel dispenser 35 can be lowered upon a sensing device 27 sensing occupancy inside a fueling parking stall 25 or remain lowered continuously.

The present figure shows the fuel dispenser 35 lowered to arm's height on the right side of the vehicle 16. The fuel dispenser 35 can be configured to first move laterally along the longitudinal central axis of the beam 3 and vertically to the below. This mobile ability makes the fuel dispenser 35 universal, reaching any side location of a vehicle's 16 fuel receptacle 44. With minimal effort, the fuel dispenser 35 can be coupled to any vehicle's 16 fuel receptacle 44 location within a fueling parking stall 25.

FIG. 2c shows an elevation of the OFS module 1 with one vehicle 16 on the left occupying a fueling parking stall 25, while the fueling parking stall 25 on the right is vacant. The signs 11, 32 coupled to the beam 3 above indicate no entry to the occupied fueling parking stall 25 and a vacancy for the vacant fueling parking stall 25.

The fuel dispenser 35 in the present figure is fully extended coupled to the fuel receptacle 44 of the vehicle 16. The fuel dispenser 35 shown reaches the fuel receptacle 44 from above. This feature minimizes slip/stumble bodily injury risk for users as well as likelihood of soiling a user's hands and/or clothing.

Further, in at least one embodiment, a retracting device 21 (concealed in this figure) can apply tensile force on the dispenser cable 45 to prevent the dispenser 45 from sagging onto the pavement 4. The retraction device 21, directly and/or indirectly with the parking manager 26, can discern at least two different steps in fueling 20 a vehicle 16. In one step, the retraction device 21 will apply no or minimal retractive force. In the other step, a retractive force of a different magnitude will be applied.

FIG. 2d shows an elevation of the OFS module 1 with a vehicle 16 on the right occupying a fueling parking stall 25, while the left side fueling parking stall 25 is vacant. The signs 11, 32 coupled to the beam 3 above indicate no entry to the occupied fueling parking stall 25 and a vacancy for the vacant fueling parking stall 25.

The above figures also show post 2 protective guards 5, an interface 31 panel coupled to the posts 2, induction coils 29 embedded in the pavement 4, and a sensing device 27 coupled to the beam 3. The parking manager 26 inputs can be received from and/or sent to devices coupled to the OFS module 1, devices embedded in the pavement 4, devices coupled to vertical structures in the vicinity, and/or remote devices.

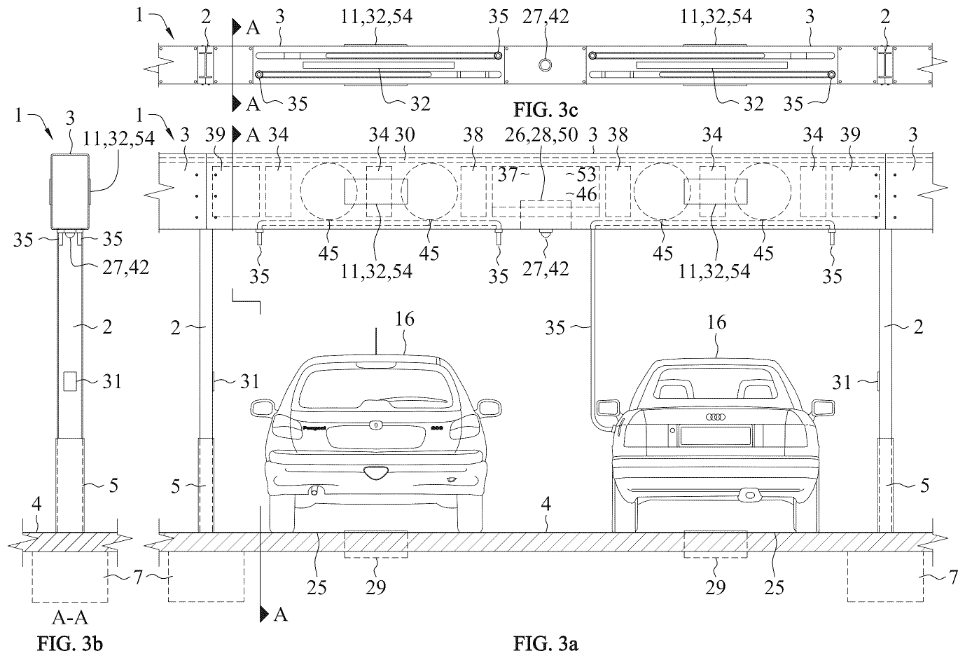

FIGS. 3a, 3b and 3c show an elevation, a transverse section, and a worm eye view respectively of an OFS with key elements concealed in a beam.

FIG. 3a shows an elevation of an OFS module 1. Coupling two partial OFS's modules 1 from the right and left to forms an OFS modules 1 array. The OFS modules 1 are mounted onto foundations 7 below the charging parking stall's 25 pavement 4. The OFS modules 1 can be the same or different from one another by at least one of: dimensions, coupled devices, means of communication interface, and/or type of fuel dispensed.

The OFS module 1 shown comprises two posts 2 and a beam 3 spanning across from the above. The posts' 2 base is shown covered by a protective guard 5. The post's 2 profile can take any form sufficient to support its own weight and the weight of the OFS' beam 3 above with coupled device assembly. The post 2 can be fabricated of metallic and/or non-metallic material. The post 2 can be painted, galvanized, and/or anodized.

Below the beam 3 and in between the posts 2 of the OFS module 1, two vehicles 16 are shown parked in fueling parking stalls 25. The vehicles 16 can be fueled 20 by fuel dispensers 35 hung from the beam 3 above or by induction coils 29 embedded in the pavement 4 of the fueling parking stalls 25. The induction coils 29 can fuel the vehicles 16 wirelessly.

The induction coils 29 can also couple to at least one sensing device 27 and/or a communication device 28. Coupled to a sensing and/or a communication device 27, 28, a vehicle 16 can navigate to an induction coil 29 automatically or manually. The communication device 28 can communicate directly with a vehicle's 16 communication device, a parking manager 26, a portable device and/or a combination of at least two devices.

An interface 31 panel mounted on at least one side of a post 2 can enable at least one transaction between a user and at least one processor 50 of the parking manager 26 of the OFS module 1. Mounted at arm's height, coupled interfaces 31 can also be on both sides of the post 2 corresponding to the fueling parking stall 25 they face.

The post 2 coupled interface 31 can be communicatively coupled to a single or a plurality of parking managers 26. The interface 31 can be wired and/or can operate wirelessly receiving power from a remote source and/or a locally generated power.

The interface 31 is one among several means of executing a transaction with the parking manager 26 communicatively. In another embodiment, the post 2 coupled interface 31 may not be needed at all, or the interface 31 can be coupled to a stand-alone structure. The stand-alone structure interface 31 can communicate with at least one or a plurality of parking managers 26 controlling the operation of one or a plurality of fueling parking stalls 25.

The beam 3 of the OFS module 1 is coupled to the support posts 2 from the above. The beam 3 supports its own weight and a plurality of coupled devices configured to facilitate dispensing fuel. The plurality of the devices shown in this figure are shown in dashed line as they are concealed inside the beam 3.

The access point to the OFS module 1 array is a defining feature of the present innovation. Fuel 20 can enter a single or a plurality of OFS modules 1 from a single point of access. These points can be from below grade or from an overhead location (not shown). From below grade, a conduit 30 reaches the horizontal beam 3 access point coupled to the interior and/or exterior of the post 2. Having a single point access to dispense fuel to vehicles 16 significantly reduces new and renovation construction costs.

In an alternate embodiment, fuel 20 can enter an OFS's module/s beam 3 from a single access point through an overhead conduit 30 (not shown). In yet another embodiment, fuel 20 can access the beam's 3 fuel conduit/s 30 entering from below grade and from an overhead location.

The conduit/s 30 entering the beam 3 can extend partially or fully along the length of at least one OFS module 1. The fuel 20 inside the conduit 30 can be conveyed by means of solid and/or stranded electrical conductor/s 52 or by pipe/s 22 conveying fluid and/or gas. The OFS module 1 is a universal structure and can convey at least one type of fuel 20 to a parked vehicle 16 in a fueling parking stall 25.

The beam 3 can be configured to have a plurality of profiles compatible with the loading capacity and operational functionality needs. The present figure shows an inverted “U” shaped beam 3 profile. The beam 3 can be fabricated of metallic and/or non-metallic material. The beam 3 can be painted, galvanized, and/or anodized.

Devices coupled to the beam 3 can be configured as integrated modules to be coupled to the beam 3, and the beam 3 can be shipped to a location partially or fully operational once at least one of: mechanical, electrical, and/or fuel connectivity is established.

The OFS module's 1 key devices shown concealed inside the beam 3 are shown in dashed line. Devices coupled to the exterior of the beam 3 are shown in solid line. The present figure shows a beam 3 configured to retain primarily concealed devices. These devices can include at least one of: a fuel charger 34 coupled to a cabled 45 fuel dispenser 35, a motor, a fuel storage device 38, an inverter/rectifier 39, a transformer 37, a switching device 46, a mechanical and/or electronic meter 53, a communication device 28, a sensing device 27, and at least one fuel conduit 30 extending a portion or the full length of the beam 3.

The devices shown coupled to the beam's 3 exterior can include at least one of: a parking manager 26, a portion of a fuel dispenser 35, a camera 27, 42, and a signaling device 32, 54 that can be illuminated. The parking manager 26 can govern the operation of the OFS module and can be communicatively coupled to at least one of: a fuel generating device 24, a fuel storage device 38, a fuel dispensing device 35, a sensing device 27, a communicating device 28, a signaling device 54, a controlling device 50, and remote user/client/s.

The parking manager 26 can govern dispensing fuel to at least one vehicle 16 parked in a fueling parking stall 25 below. The parking manager 26 can include a processor 50 with resident memory and code 55. The code 55 can employ at least one AI algorithm. One of the Al's code 55 algorithms can include self-learning.

The processor 50 of the parking manager 26 is coupled to at least one of: sensing 27, communication 28, and fuel charging 34 device/s. In addition, the processor 50 can be communicatively coupled to an array of I/O devices. The processor 50 processes inputs in real time, acting on needs and events that occur within at least one fueling parking stall 25. The needs and events response capability of the parking manager 26 code 55 can include predictable algorithms that can anticipate an event consequence and act preemptively to prevent the occurrence.

The present figure shows a camera 42 coupled to the bottom of the beam 3. The camera 42 in real time surveys and communicates to the parking manager's processor 50 at least one input observed within at least one fueling parking stall 26 below. The camera's 42 utility can be expanded to also serve as an occupancy sensor and a photocell.

Further coupled to resident logic or transmitting inputs to the parking manager's processor 50, the camera 42 alone or in unison with other sensing devices 27 can observe user difficulties, recognize threats to humans by human behavior and/or audio input, threats to equipment by at least visual, audio and/or thermal monitoring, and can issue alerts.

The figure shows two signs 11 coupled to the wall of the beam 3. The signs 11 can be illuminated 32 showing alphanumeric text and/or symbols. The signs 11 can alternate color, text and/or symbols. The sign's 11 prime purpose is to inform a user of the occupancy status of a fueling parking stall 25. However, in at least one other embodiment the sign 11 can inform a user about the type of fuel 20 the specific fueling parking stall 25 is configured to dispense.

The figure also shows four fuel dispensers 35 hung below the beam 3. Two of the fuel dispensers 35 service two vehicles 16 on one side of the beam 3 while the fuel dispensers 35 service vehicles 26 on the opposite side of the beam 3. In another embodiment, the fuel dispensing 35 can be from a single side of the beam 3, and the beam 3 can couple to any vertical structure including a wall (not shown).

Above the left side fueling parking stall 25, a fuel dispenser 35 is shown resting in its first station also referred herein as the fuel dispenser's 35 default position (driver side). In at least one embodiment the fuel dispenser 35 can have lateral mobility that can extend from one side of a vehicle 16 to the other side. While not all OFS modules' 1 dispensers 35 can be fitted with dispenser mobility, such solution novelty makes operating the cabled 45 fuel dispenser 35 easier.

Above the right-side fueling parking stall 25, a fuel dispenser 35 is shown hung from the beam 3 to a user's approximate arm height. The fuel dispenser 35 shown is in the second station. The second station can occur after an automated and/or manual authorization has been received through a parking manager 26 authorizing the vehicle 16 to enter the fueling parking stall 25 and/or to fuel 20 a vehicle 16.

In at least one embodiment, the parking manager 26 can recognize the side of the vehicle 16 where the fuel receptacle 44 is located, and upon obtaining fueling authorization can initiate at least one of: move a fuel dispenser 35 laterally and/or vertically, or navigate a vehicle to an induction coil's 29 optimal charging location within a fueling parking stall 25.

FIG. 3b shows a transverse A-A section through an OFS module 1. The elements shown include a foundation 7, a post 2 with a coupled interface panel 31, and a bottom section protective guard 5. A beam 3 coupled to the post 2 and devices coupled to the beam 3 include a camera 42, fuel dispensers 35, and signs 11.

FIG. 3c shows a worm eye view of an OFS module 1. The elements shown include posts 2, fuel dispensers 35, light sources 32, a camera 42, the bottom of the beam 3, and signs 11 coupled to the exterior surfaces of the beam 3.

The figure shows the bottom face of the beam 3 having two fuel dispensers 35 on the right side of the beam and two fuel dispensers 35 on the left side of the beam 3. Each side dispenser 35 fuels vehicles 16 parked at opposite side of the beam 3. Since the fuel dispensers 35, at least in the present embodiment, are configured to be on the driver's side, the fuel dispensers 35 are shown at opposite sides to one another.

The fuel dispensers 35 can travel laterally along the longitudinal axis of the OFS' beam 3 and vertically. In at least one embodiment, the fuel dispenser's 35 mobility can be motorized to move laterally and/or vertically. In another embodiment, the fuel dispenser 35 can employ a mechanical and/or electrical retraction device 21 that applies retraction force to retract the fuel dispenser 35 upwardly upon completing a refueling cycle.

The bottom face of the beam 3 can comprise several removable covers. The covers can cover internal compartments housing key devices of the OFS. The devices can be configured as “Plug N′ Play” modular elements with receptacles that are pre-configured to join these devices to at least one network of power and/or data distribution.

On the sides of the beam 3, coupled signs 11 indicate the vacancy status of a fueling parking stall 25. The sign 11 can be illuminated 32, and the color of the sign can change at least in part based on the occupancy status of the fueling parking stall 25. At both ends of the beam 3, posts 2 shown retain interface panels 31 that enable users to obtain authorization to fuel 20 a vehicle 16.

In yet other embodiments of the OFS module, no externally mounted interface panel 31 may be needed for obtaining authorization/s. The authorization/s can be obtained by communicating directly with the parking manager 26 through at least one of: a handheld device, a vehicle 16 built-in interface 31, and/or through an interface 31 coupled to the fuel dispenser 35.

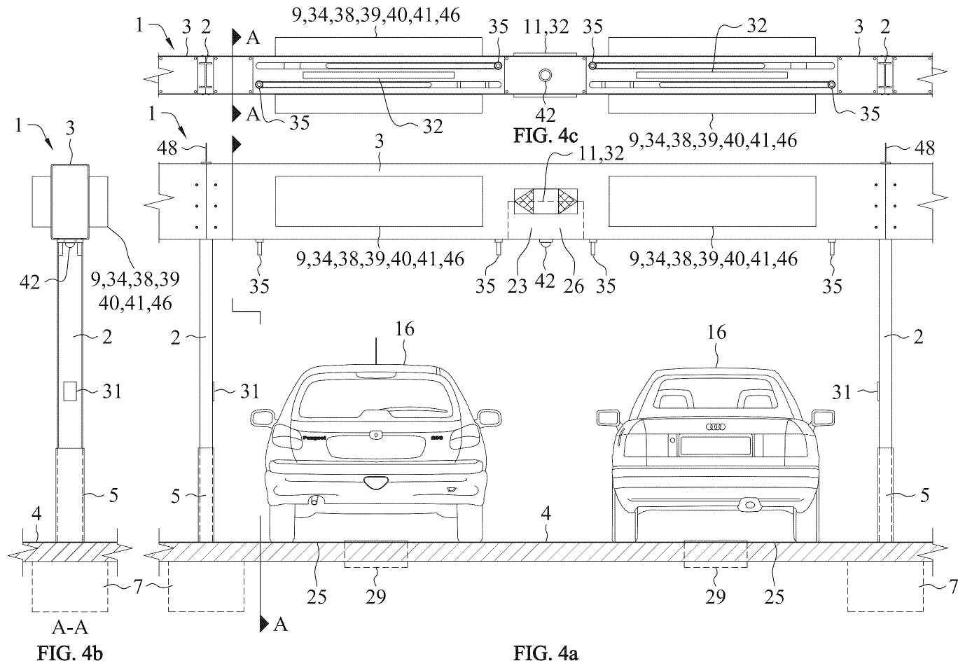

FIGS. 4a, 4b and 4c show an elevation, a transverse section, and a worm eye view respectively of an OFS module. The present embodiment structure is similar to FIGS. 3a-c; however, unlike FIGS. 3a-c, it shows several of the fuel fueling devices on the beams' exterior surfaces.

FIG. 4a shows at the center of the beam 3 a single sign 11 with arrows pointing to the right and the left. The single sign 11 is configured to inform users of the right and left side charging parking stalls the readiness of a fueling parking stall 25 to receive a vehicle 16. The arrows shown in this example can be green illuminated by a light source 32 showing a charging parking stall ready for a vehicle 16 to enter, and red illuminated 32 when entry is disallowed.

In addition to an illuminated sign 32, 11, at least one audio device 23 such as a speaker can be communicatively coupled the parking manager 26 of the OFS (not shown). The audio device 23 can at least announce when entry to the fueling parking stall 25 is allowed or forewarn a user when the user parks a vehicle 16 in the fueling parking stall 25 illegally. Illegal parking can include exceeding the time allowed for a reasonable fueling cycle.

Furthermore, there are other means to address users that illegally park their vehicles 16 in fueling parking stalls 25. The parking manager 26 camera 42 can associate a vehicle's 16 license plate with the vehicle's 16 owner. This information, with an image of the user, can lead to several punitive actions, from automated electronic mailing of tickets to physical removal of the vehicle 16 from the fueling parking stall 25.

The present figure shows coupled exterior devices on both sides of the beam 3. These devices can include at least one of: a fuel charger device 34, an inverter/rectifier 39, a power fuel device 38, a switch 46, a panel 40, a valve 9, a surge protector 56, and/or a motor 41.

Placing such devices on the beam's 3 exterior improves accessibility and reduces time in maintaining the system. Devices external to the beam 3 can be configured and modularly arranged as stand-alone or in combination with other devices. These external devices can then be coupled to a tray, and the tray can then be coupled to the beam 3.

Other devices shown coupled to the beam 3 include a bottom facing camera 42 and four fuel dispensers 35. In addition, two charging induction coils 29 are shown embedded in the fueling parking stall 25 pavement 4 and interface panels 31 coupled to the posts 2. An element not shown that can be coupled where electrical storms are prevalent is a lightning arrester 48. The lightning arrester 48 can be coupled to the top of the beam 3 or the post 2 with ground wire directing electrical power to the ground directly below.

FIG. 4b shows a transverse section A-A of an OFS module 1. The elements shown include: a foundation 7, a post 2 with a coupled interface panel 31, and a protective guard 5 at the bottom section of the post 2. A beam 3 coupled to the post 2 from above shows: a camera 42 and a fuel dispenser 35 coupled to the bottom of the beam 3. On both sides of the beam 3, the elements shown can include at least one of: a fuel charger device 34, an inverter/rectifier 39, a power storage device 38, a switch 46, a breaker panel 40, a valve 9, a surge protector 56, and/or a motor 41.

FIG. 4c shows a worm eye view of an OFS module 1. The elements shown include posts 2, fuel dispensers 35, light sources 32, a camera 42, the bottom of the beam 3, and signs 11 coupled to the exterior surfaces of the beam 3.

The figure shows the bottom face of the beam 3 having two dispensers 35 on the right side of the beam 3 and two dispensers 35 on the left side of the beam 3. Each side dispenser 35 fuels vehicles 16 parked on opposite sides of the beam 3 when the fuel dispensers 35 are configured to be on the driver's side.

The present figure also shows devices coupled to both sides of the beam's 3 exterior. These devices can be configured to be coupled to mounting trays (not shown) and then the tray couples to the beam 3 or is directly mounted to the beam 3. The devices can be housed in an enclosure that can retain at least two devices with an access panel (not shown).

In addition, the devices can be factory configured to ship to location fully assembled, coupled, or detached from the beam 3. The present innovation anticipates a modular “Plug N′ Play” device assembly fully configured to ship from factory, assembled with labor in the field limited to coupling the beam 3 to posts 2 and/or other vertical structures.

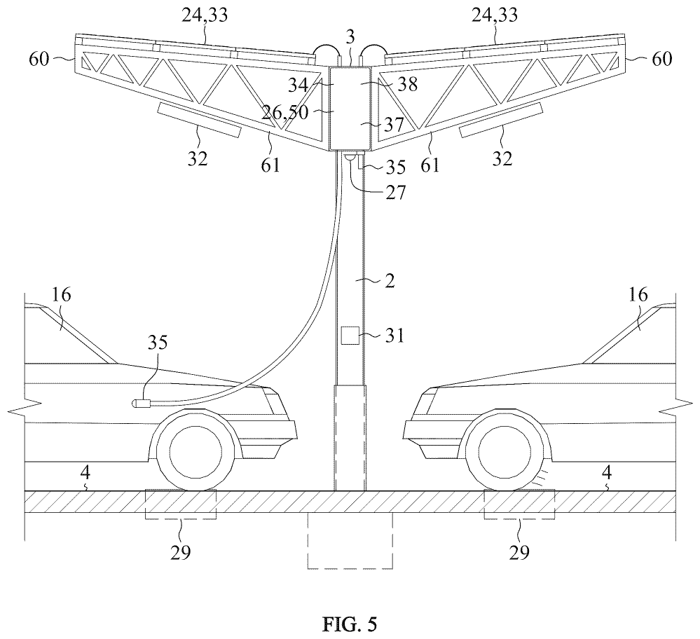

FIG. 5 shows a transverse section through an OFS module with fuel charging devices and canopies coupled to both sides of the beam.

Below the beam 3, a partial view of two vehicles 16 is shown parked within the fueling parking stalls 25. The vehicles 16 are oriented head-to-head with the OFS's module 1 posts 2 between and the beam 3 above the vehicles 16. The vehicle 16 on the left side is fueled by a fuel dispenser 35 originating from the above, while the vehicle 16 on the right side is fueled by an induction coil 29 embedded in the pavement 4. An interface panel 31 is shown on the post 2.

In addition to the elements already described in FIGS. 3a-c and FIGS. 4a-c, an additional element shown includes two open web trusses 61 coupled to the opposing sides of the beam 3. A light source 32 device is shown coupled to the bottom member of each truss 61, and at least one photovoltaic panel 33 is coupled to each truss' 61 top member.

Power generated by the photovoltaic panel 33 can be stored inside a storage device 38 couple to the beam's 3 interior and/or coupled to the beam's 3 exterior. The power generated can be used, at least in part, to fuel vehicles 16 parked below and/or can be transmitted to a remote high demand user such as a utility during the day, whereas at night the fuel 20 can be returned and used by the OFS and/or distal pole mounted devices.

The canopy's 60 fuel generating device 24 can be sized to approximate the connected load of at least a portion of the parking facility. Such demand can be generated by at least one of fuel consuming devices including: a fuel charger 34, a light source 32, a signal emitter 11, a processer 50 coupled to the parking manager 26, a communication device 28, a transformer 37, and an array of sensing devices 27.

Where natural energy including wind, solar, ocean current and geothermal is abundantly available, the present innovation foresees the OFS' extensive use of these natural resources. As fuel generating 24 and fuel storage devices 38 become more efficient, this innovation foresees the OFS becoming self-reliant off the grid.

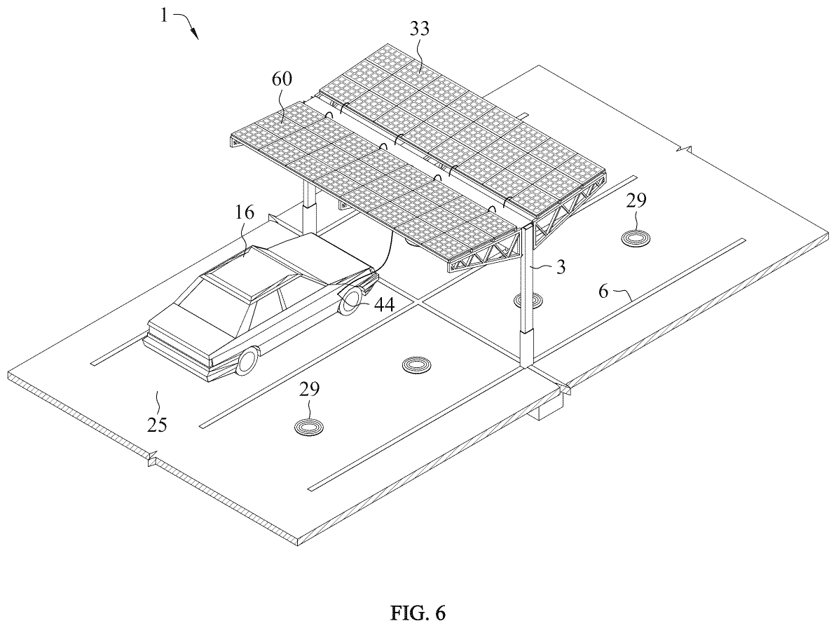

FIG. 6 shows a perspective of a single OFS module 1 section with a double-sided canopy 60. Coupled with other OFS modules 1, an OFS array is formed. The present canopies 60 shown retain photovoltaic panels 33 and wireless charging induction coils 29 embedded in the pavement 4 below of the fueling parking stalls 25.

Below the canopy 60 a vehicle 16 is shown being charged by a fuel dispenser 35 hung from above coupled to a fuel receptacle 44 located on the right side of the vehicle 16. A light source (not shown) can be coupled below the canopy 60 illuminating the fueling parking stall 25 below. Other devices not shown can include: lightning arresters 48, other means of fuel generating device/s, and air pollution scrubbers (not shown).

Fuel 20 generated by the photovoltaic panels 33 can be stored in fuel storage device/s 38 coupled to the OFS' structure including at least one canopy 60. In addition, inverter/s/rectifier/s 39 can be coupled to the fuel storage device/s 38 and/or the parking manager 26 and can be locally mounted on an OFS' module 1 and/or mounted remotely (not shown).

The present figure shows the canopies' 60 orientation with an incline from the beam 3 outwardly. The purpose of this incline is to both divert rain/icicles away from a user and to improve the visibility of the sign 11, 32 (not shown) showing the fueling parking stall's 25 vacancy status.

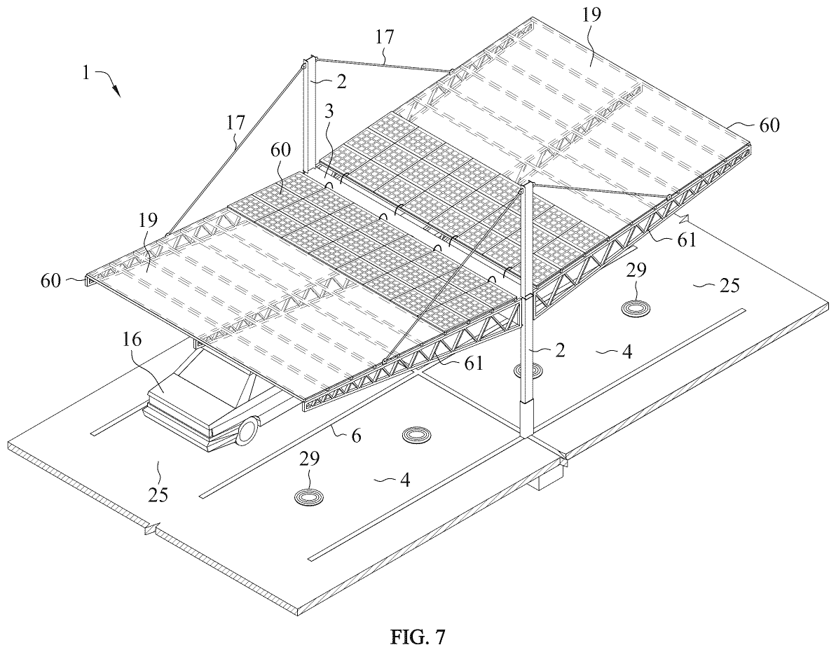

FIG. 7 shows a perspective of a single OFS module 1 section with a double-sided canopy 60. Coupled with other OCS modules 1, an OFS array is formed. The present canopies 60 shown are comprised of two sections each. One section retains photovoltaic panels 33, and the other section retains shading devices 19.

The canopies 60 extend above the full length of the fueling parking stalls 25 below. Given the canopies' 60 cantilevered span, additional support is shown with a post 2 extending above the canopies 60, and tension cables 17 coupling the canopies 60 to the posts 2 secure the canopies 60 in place. The present figure exemplifies one configuration for supporting a full-length canopy 60 over fueling parking stalls 25. A deeper height beam 3 and/or a truss 61 can accomplish the same results without additional support.

In another embodiment, the canopy 60 can comprise a shading device 19 only or in combination with at least one of: a beam 3, and/or a canopy 60 supported device/s described with FIG. 6. Also as shown in FIG. 6, wireless fueling induction coils 29 are shown embedded in the fueling parking stalls' 25 pavement 4 and a partial view of a parked vehicle 16.

FIGS. 8a and 8b show in plan and perspective view respectively partial vehicular head-to-head double sided parking stalls reconfigured as fueling drive lanes.

FIG. 8a shows in plan view two through drive lanes formerly served as double-sided parking stalls with vehicles parked head to head. The short end's striping of the parking stall has been removed to enable vehicles to enter from one side of the drive lane and exit from the opposite side of the drive lane.

The typical length of a parking stall is approximately 20 ft. The present figure shows coupled driving stalls that form 40 ft. long drive lanes. Two OFC fueling modules are disposed transversely over the drive lanes. Each OFC fueling module is disposed 10 ft. from both ends in and 20 ft. between one and another. The present configuration can couple to another like configuration extending several modules with several drive lanes below, and with or without a canopy mounted above.

The present figure shows three vehicles being fueled. The vehicles are parked on the pavement of the drive lanes with posts disposed at the opposite sides of the two drive lanes and the beam is coupled to each pair of posts from above. A canopy mounted above the beams extends the entire area of the drive lanes below. Perpendicularly oriented stripes are shown on the opposite sides of the module. These stripes represent a continuation of the double-sided parking stalls, now repurposed to facilitate the fueling parking stalls' drive lanes.

FIG. 8b shows a perspective view of two fueling driving lanes' module capable of fueling up to four vehicles concurrently.

The fueling driving lanes are delineated by striping on the pavement. A canopy supported by a plurality of joists. The joists are supported by the beam and the beam is supported by the posts. The posts are located on or in proximity to the former parking stalls' striping. The use of the overhead fueling system over existing parking stall modules eliminates the need to modify the facility's parking stall striping.

It should be apparent that the present layout of a fueling driving lane and the alternate fuel used may not fall under construction codes regulating the width of a drive aisle for fossil fuel vehicles. The present layout may trigger changes in the current code. The changes can come as a result of employing at least one fuel type that does not pose risks to users and/or property.

FIG. 9 shows a diagram of a parking facility with fueling and non-fueling parking stalls located within an urban environment.

The parking facility “PF” shows three double-loaded parking stalls 18 “A”, “B” and “C”, double-loaded fueling parking stall “D” 25, and single-loaded fueling parking stall “E” 25. The latter also shows single-sided canopies 60 coupled to the OFS modules 1.

Parking stalls 18 “A” and “C” show poles 59 with two luminaires 62 located at both ends of the continuous stalls 18, with an additional pole 59 with two luminaires 62 located at the mid-point of the stalls 18.

Fueling parking stalls 25 “D” and “E” show an array of OFS modules 1 coupled to one another along the narrow side of the fueling parking stall's 25 striping 6 below. The fueling parking stall 25 “D” shows induction coils 29 coupled to the stall's 25 pavement 4 and fueling parking stall 25 “E” shows poles 59 arranged in similar locations to the poles 59 shown in parking stalls 18 “A” and “C” with only a single luminaire 62 coupled to a pole 59.

The parking facility PF is located within an urban environment and surrounded by streets WW, XX, YY and ZZ. Pole 59 mounted streetlights 58 are shown located along at least one side of each of the streets. A parking manager 26 coupled directly or indirectly to a pole 59 can then be communicatively coupled to at least one parking manager 26 located within the parking facility “PF”.

Three traffic lights 57 are shown on the common corner to street “XX” and “YY”. These traffic lights 57 can also couple to at least one roadway parking manager 26 and a parking facility “PF” parking manager 26. The communication connectivity between the fueling and/or the parking managers 26 can at the very least better manage traffic flow between the parking facility and the public roadways.

The network of roadways extends throughout the urban environment, and the attributes of the parking manager citywide are described in more detail in the Applicant's U.S. Pat. Nos. 10,653,014, 11,071,204.

The present diagram shows on the right side of the page key networked clients that can couple to at least one fueling parking manager 26 of an OFS module 1. These clients can include at least one of: a vehicle owner, a facility office, a municipal department, a first responder and a financial institution.

The communication shown is direct (point to point). However, the communication can also be exchanged by means of a mashed network assigning to specific parking managers additional and/or different tasks, and/or through one or several intermediate device/s such as data aggregators/s/disseminator/s (not shown).

A centralized processor or a plurality of hub processors configured as data I/O aggregator/s/disseminator/s operating on AI logic with fast processing capability such as quantum computer/s can in real time receive and transmit inputs and instructions throughout the network, applying rules as to priority, sequencing, and need to know clients.

For reasons of clarity, the present diagram shows only data exchanged between a single fueling parking stall manager and remote clients. Nonetheless, the fueling parking manager is communicatively coupled to at least one of: a sensing device and an output device. The fueling parking manager is also communicatively coupled to neighboring parking managers of the same configuration, or a different configuration, within the same parking facility and/or outside the parking facility.

The utility that can be derived from the present diagram's configuration can include:
a. Measured and controlled response to a local and/or a remote event
b. Individual device information and instruction I/O on need-to-know basis
c. Real time inputs flow triggering instantaneous coordinated response/s
d. Navigational assistance between public and private domains
e. Expanding existing infrastructure to better serve the community
f. Minimizing the operational demand on service provider/s and machinery

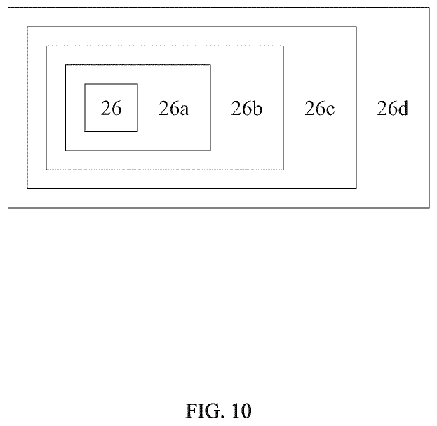

FIG. 10 shows a diagram of an OFS' fueling parking manager's communication with managers corresponding to fueling, pole/s, streetlight/s, traffic and greater urban environment parking managers.

The parking manager, at least in part, governs device functionality within a domain. The parking manager manages several area domains within an urban environment. The domains are configured to overlap, forming a mashed communication network.

These domains can include a roadway intersection parking manager, a roadway parking manager, a parking manager and a fueling parking manager. The OFS fueling parking manager governs device operation within at least one fueling parking stall.

The present diagram shows a fueling parking manager at the center of a plurality of concentric rings. The farther the communication parking manager and/or remote client is located from the center, the lesser the communication traffic is between the fueling parking manager 26 and the location of the outer ring. The communication traffic of the outer ring device can be single and/or bi-directional with the coupled networked devices.

The present diagram shows conceptually the individual fueling parking manager 26 located adjacent to neighboring fueling parking managers within OFS' fueling parking stalls 25. The totality of the fueling parking stalls 25 is shown within a parking facility with parking managers 26b that can have a plurality of ordinary non-fueling parking stalls 18.

The parking facility parking managers 26, 26a and 26b are located within a neighborhood with roadways leading to it. Roadway parking managers 26c coupled to at least streetlight 58 poles 59 and/or traffic lights 57 can then expand the roadway parking manager's 26c mashed communication network. Finally, the network of parking managers 26, 26a, 26b and 26c coupled to OFS modules, poles, and streetlights in the vicinity of the parking facility can proliferate throughout the urban environment with at least some parking managers 26d coupled to vertical structures along the roadways.

The fueling parking manager can communicate through a mashed network, through point to point, and/or through a combination of methods thereof. The fueling parking manager AI code can discern in real time input and output transmission to the appropriate clients. The devices controlled by the code are configured to operate in unison within other fueling parking manager controlling other domains as well as with at least one remote fueling and/or non-fueling parking manager.

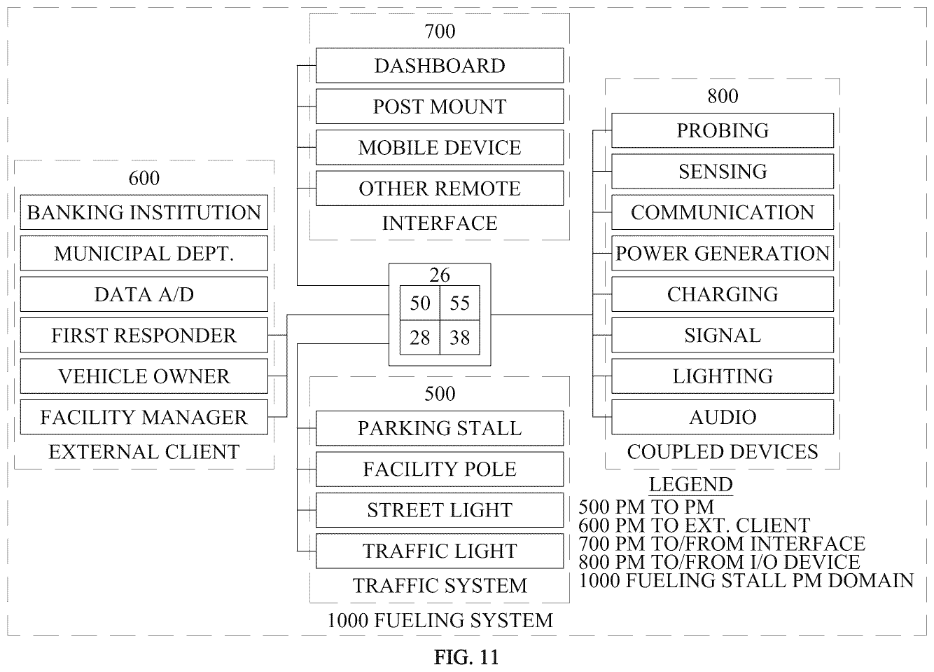

FIG. 11 shows a block diagram of devices and clients the OFS' parking manager is communicatively coupled to.

The parking manager of the OFS comprises at least one processor with resident memory and code and a communication device. The processor, also configured as a controller, through the communication device is communicatively coupled to internal devices and external/remote clients. The remote clients can be humans and/or machines. The parking manager communication can be bi-directional, receiving/sending inputs/output data and/or instructions to coupled devices and/or remote clients.

The code operated fueling parking manager can be communicatively coupled to at least four device categories. These categories include:
a. External clients
b. Parking and roadway managers
c. Interface devices
d. Sensing and output devices

External clients—The external clients can include municipal departments, first responders, banking institutions, vehicle owners, and a facility management office. Another external client can be an I/O aggregator/disseminator processor flowing inputs between the parking manager and the above listed clients.

The I/O can be prioritized, discriminatory in messaging a client/s, directing device action, all in real time. The aggregator/s/disseminator/s can be configured as a centralized I/O hub, or the network can employ several hubs reducing data flow traffic.

Parking and roadway managers—The parking and roadway managers inform one another about conditions in their designated area of coverage-their domain. The present innovation presents four types of managers: a fueling parking manager, a parking manager typically coupled to a pole or a ceiling, a roadway parking manager coupled to a streetlight, and a traffic parking manager coupled to a traffic light. Other types of parking managers can be added on an as-needed basis.

Interface—The fueling parking manager can couple to at least one user interface. The interface can be coupled to a vertical structure within arm's height, built into a vehicle's dashboard, and/or available through an app on a stationary and/or mobile device. The interface enables a user to interface with the OFS parking manager to execute at least one transaction.

Coupled devices—The fueling parking manager processor is coupled to sensing, input, and output devices. The sensing devices can include: a camera, a speaker, a microphone, a lighting device, a signaling device, a motion sensor, a photocell, an air quality probe, a sound cancellation device, a vibration sensor, and a thermal sensor.

Input and output devices can include: a fuel charger with a dispenser, a power generating device like a wind turbine or a photovoltaic panel, an air scrubbing device that removes pollutants, a fuel storage device, an inverter/rectifier, and a switch.

The categories listed above, the clients, and the devices can vary, and the same goes for the processing and communication capabilities of the fueling parking manager.

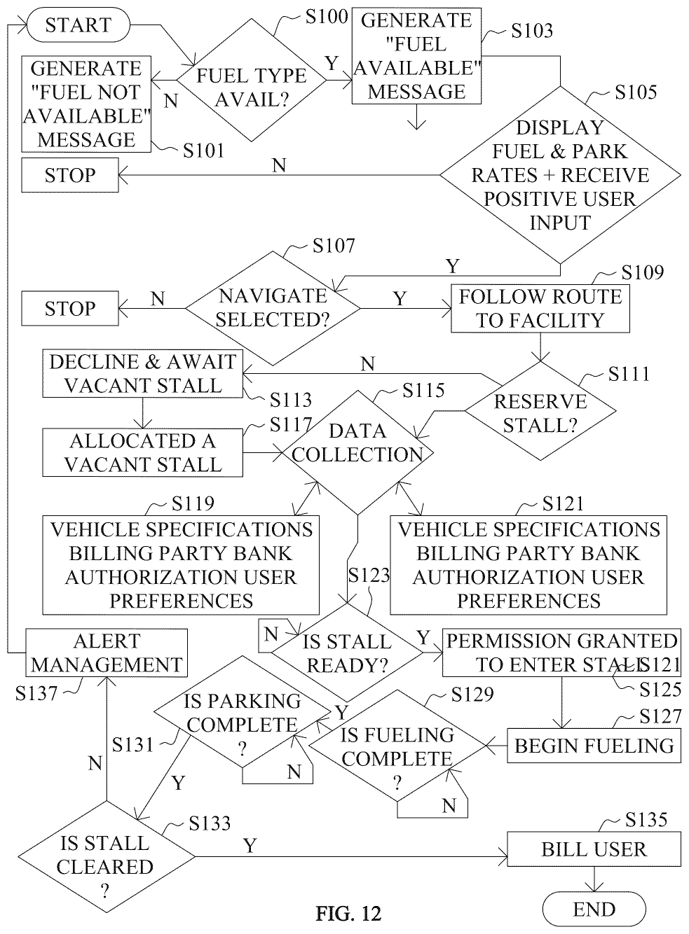

FIG. 12 is a flow chart illustrating an example process flow of locating, navigating, and fueling a vehicle communicatively by a user and/or a vehicle with an option for pre-granted authorization to park and fuel a vehicle.

A user interfacing with a vehicle dashboard console, a stationary or a mobile device can find a fueling facility with a suitable fuel, geographical proximity, pricing and, timely fueling accessibility from a remote location.

Further, the user can in advance reserve a fueling time slot and pay in advance. The user can accept and follow navigational instructions to the fueling parking stall or decline the instructions.

The user and/or the vehicle may have a subscription and or pre-authorization to fuel the vehicle, and upon entering a fueling facility the user and/or the vehicle can be directed to a vacant fueling parking stall.

The database of the AI code can at least retain one of: information that associates a vehicle with a user, the vehicle's specifications, the billing methods, the financially responsible party, and the user preferences.

The billing for fueling can be charged dynamically where the cost of fuel may vary by time of day, day of the week and or season of the year. The fee schedule can also be communicated to users in advance, inviting user/s to save while optimizing round the clock use of the fueling facility.

Leaving a vehicle in a fueling parking stall is discouraged. For this, users leaving their vehicles in fueling parking stalls beyond a reasonable time may be subject to escalating parking charges.

The process shown in the flow chart of FIG. 12 begins in step S100 where a query is made regarding what type of fuel is available at OFSs within a particular “ring” as describe in FIG. 10. If the response to the query for a particular ring (e.g., adjacent OFS, OFSs within a neighborhood, etc.) is negative, the process proceeds to step S101 where a generate “not available” message is sent in reply to a query transmitted from a user device (e.g., smartphone and/or on-board computer in a vehicle). On the other hand, if the response to the query in step S100 is affirmative, the process proceeds to step S103 where another message is generated, indicating that the fuel is available. This serves as an indication that the particular OFS is a candidate for fueling that particular vehicle. Alternatively, the vehicle may self-report the kind of fuel being sought, and the parking manager replies regarding whether there is a match. Likewise, image detection and vehicle/fuel identification may be auto performed with the AI engine discussed with respect to FIGS. 17-19.

Returning the main embodiment of FIG. 12, in both steps S101 and S103 the user's electronic device (e.g., smartphone, or vehicle equipped display, or other device) may be used for the display generated by the processor. After step S103, the process proceeds to another query in step S105, where the processor causes a display of fueling rates and parking rates. (Optionally, just fuel rates may be displayed, or just parking rates may be displayed). As part of the query in S105, the query includes whether receipt of a positive user input is obtained. If the response to the query in S105 is negative, the process stops. However, if the response to the query and step S105 is affirmative, the process proceeds to step S107, where another query is made, regarding whether the navigation has been selected. If the response is negative, then the process stops. Alternatively, manual navigation of the vehicle may be performed. However, if the response to the query in step S107 is affirmative, the process proceeds to step S109 in which a route to the facility is displayed or provided to the vehicle for either autonomous driving, or manual driving to the facility.

After step S109, the process proceeds to another query in step S111, where the query is whether a stall has been reserved. If the response is negative, the process proceeds to step S113 where the decline of the reservation is recognized, and the vehicle waits until a stall is vacant. Then, in step S117, the process identifies a vacant stall and allocates the stall to the vehicle. Then the process proceeds to step S115. Likewise, if the response to the query in step S111 is affirmative, the process also proceeds to step S115, where the processor queries different sources of information in order to obtain data.

In step S119, in response to the query from the processor, or through a push operation, a database having vehicle specifications including the billing party's bank authorization information as well as user preferences, are downloaded to the processor. Also, in step S121, vehicle specifications are downloaded, as well as the billing party bank authorization and user preferences are also provided to the processor. Then, once the data is collected in response to the query in step S115, the process proceeds to step S123, where another query is made regarding whether the stall is ready to be occupied by the vehicle. If the response is negative, then a delay loop of a predetermined delay (e.g., as a non-limiting example, any time from one second through 5 minutes) continues until the query is made once again. However, if the response to the query in step S123 is affirmative, the process proceeds to step S125, where permission is granted for the vehicle to enter the stall. Subsequently, in step S127, the fueling process begins and the process proceeds to step S129, where a query is made regarding whether the fueling is complete. If the response is negative, then the process enters a delay loop (e.g., as a non-limiting example a time between one second to one minute) before returning to the query in step S129. However, if the response to the query in step S129 is affirmative, the process proceeds the step S131, where another query is made, regarding whether the parking duration has been completed. If the response is negative, the process proceeds in a delay loop (e.g., as a non-limiting example 1 minute to 10 minutes or the like) before making the query again.

Once the response that that query is affirmative, the process proceeds to another query in step S113, whether the stall has been actually cleared. If the response to the query and step S133 is affirmative, the process proceeds the step S135 where the user is billed and then the process ends. However, if the response to the query in step S113 is negative, it means that the vehicle is no longer authorized or remains in the stall and so the processor generates an alert message to send to a management organization in step S137 so the management organization may take action to remove the vehicle. After the completion of step S137, the process returns to the beginning of the process flow.

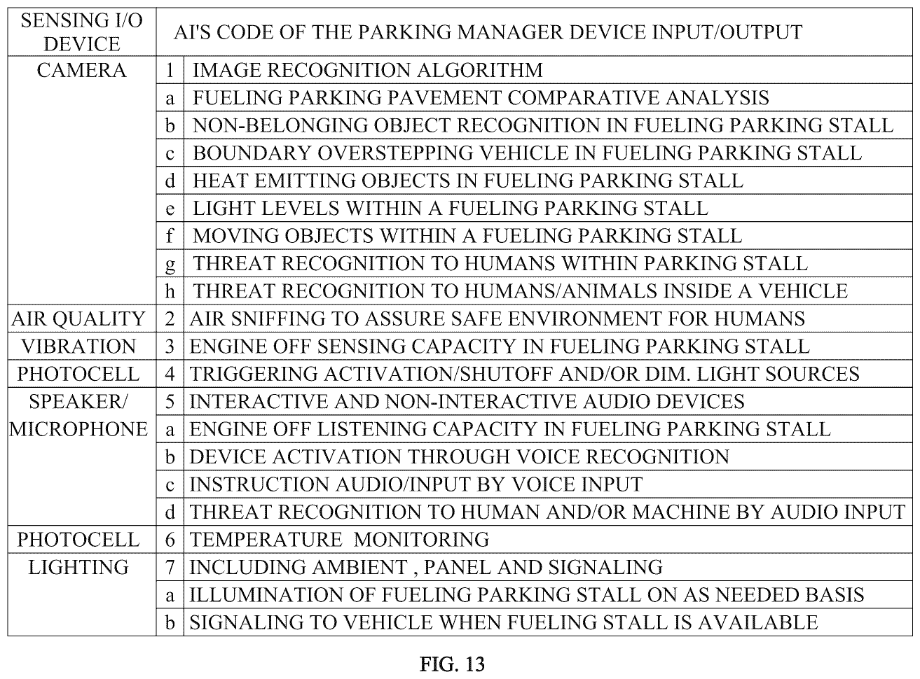

FIG. 13 is a table of an array of devices that are communicatively coupled to the parking manager's processor with AI code processing input in unison, in real time and generating prioritized outputs.

The devices shown include input and output devices. Not shown are fuel generating and air filtration devices. It is noted that the processor of the parking manager can be configured to communicate with, or communicate with and control and coupled device.

The input received by the parking manager's code can be received from coupled in the vicinity and/or remote devices. The inputs can be data and/or instructions. The devices shown on the table include: a camera, air quality sensor, a vibration sensor, a photocell, a speaker/microphone, a thermal sensor, and a lighting device.

Each one of these devices can be controlled individually and/or in unison with other devices. Inputs from these devices can be assessed by the AI code individually and/or in unison with at least one other device input.

The AI code is generally configured to receive inputs from a plurality of input generating devices and can generate outputs in real time. The outputs can include activating and/or de-activating devices within the fueling parking manager domain as well as communicating with neighboring and/or remote devices.

The devices listed can have multiple functionalities. In addition, operating in conjunction with at least one more device can expand the devices' capabilities and provide more granular inputs for the code, thus enabling the AI engine to control the OFS more efficiently and/or in safer manner.

The inputs received from the at least listed devices can be weighted in terms of importance under varying circumstances. Life safety is paramount and for this, the AI code algorithms can establish life safety as the prime priority for a response output. The AI code can be trained to anticipate events and response in a consistent repeatable manner under the same sets of inputs.

The AI code can employ learning algorithms that learn the fuel parking manager's domain and continuously improve the operations' performance.

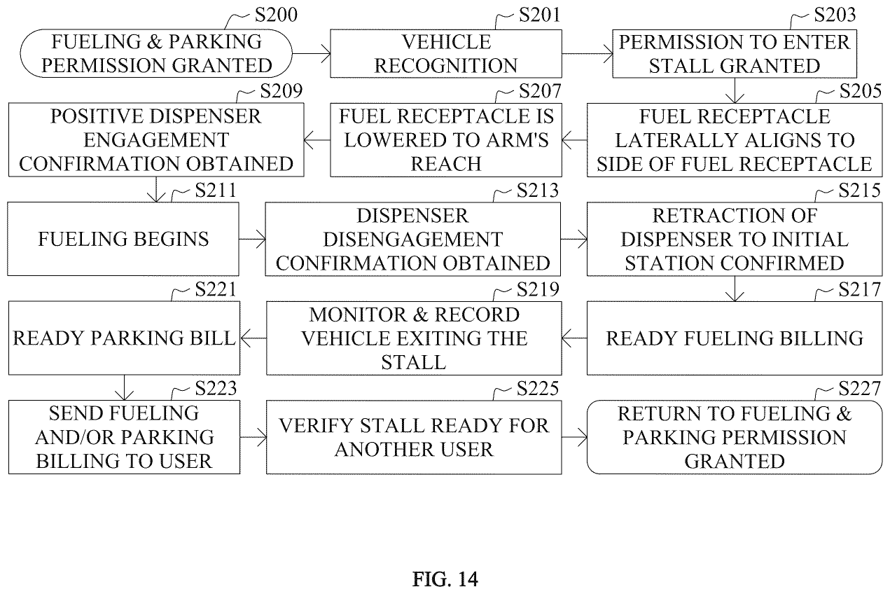

FIG. 14 is a flowchart of a process for fueling a pre-authorized vehicle from entering to exiting a fueling parking stall. The process begins in step S200 where the processor grants permission for a vehicle to park and be fueled in a stall. The process then proceeds to step S201 where a vehicle recognition process is implemented. The recognition may be performed through image recognition with the assistance of the AI engine discussed later with regard to FIGS. 17-19. The process then proceeds to step S201 where the processor grants permission for the vehicle to enter the stall.

The process then proceeds to step S205 where the fuel receptacle (or vehicle mounted pick-up coil) of the vehicle is laterally aligned with a side on which the fuel dispenser is located (or aligned over top of a ground mounted charging coil). For overhead dispensing, as previously discussed, each fuel dispenser is movable to a right side or a left side of the vehicle. The lateral alignment is done via visual detection of the fuel receptacle on the vehicle and the known location of the fuel dispenser, or alternatively, via a priori (perhaps via image recognition or the AI engine of FIGS. 17-19) knowledge of the type of vehicle and where the fuel receptacle is located on that particular vehicle. The process then proceeds to step S207 where the fuel dispenser is lowered to an arm's reach (e.g., from 3′ through 7′). The fuel dispenser is terminated with a nozzle, connector, or gas fitting at the end of tubing or a cable. The cable/hose terminal is mechanically configured to be received by the vehicle's fueling receptacle. In the case of a gasoline powered vehicle, a nozzle provides at least one of gasoline or diesel fuel to the vehicle. Alternatively, the vehicle may be detected as being fueled by a different type of fuel, such as hydrogen or electricity. If the fuel is hydrogen, the terminal at the end of the fueling receptacle is one of a gas fitting that is configured to dispense a gaseous form of hydrogen or an interlocking terminal that conveys a liquid form of hydrogen there through. The hydrogen is controlled to flow after confirmation of a mechanical attachment to the vehicle's fuel receptacle and a sensor detects a successful attachment and seal, which then triggers the controlling processor to release a controlled amount of hydrogen to the vehicle. Electrical fueling operates in a similar manner, although a different connector that is compatible to the charging receptacle on the vehicle is used by the overhead fueling system to provide electricity to charge the vehicle via the vehicles charging receptacle. For inductive charging with an underlying charging coil, charging may commence once proper alignment with the vehicle's pick-up coil(s) is confirmed.

In the case of mechanical engagement of the dispenser with the vehicle's receptacle, once successful attachment of the dispenser is recognized in step S209, and subsequently once the engagement is determined, fueling begins in step S211. Subsequently, the dispenser is disengaged from the vehicle's fuel receptacle and confirmation of the same is obtained in step S213. Subsequently the process proceeds to step S215 where the dispenser is retracted.

The process then proceeds to step S217 where billing for the fueling operation is prepared. The fuel bill is conveyed in a digital message to a computer-based service for which the user of the vehicle has an account (step S219). Moreover, monitoring and recording of the vehicle's fueling experience in the stall prior to the exiting of the vehicle from the stall is performed at this stage. The process then proceeds to step S221, where a message is dispatched from the processor regarding the a parking bill for the time the vehicle was located in the stall. Subsequently the process proceeds to step S223 where the fueling and parking bills (invoices) are provided to another electronic device that processes the payment and invoices the user. The process then proceeds the step S225 where verification is performed of the stall being available for another vehicle. This may be performed by visual detection by an overhead camera that takes an image and verifies that the stall is empty. Subsequently, the process proceeds to step S227 where the process repeats in steps 200 for another vehicle.

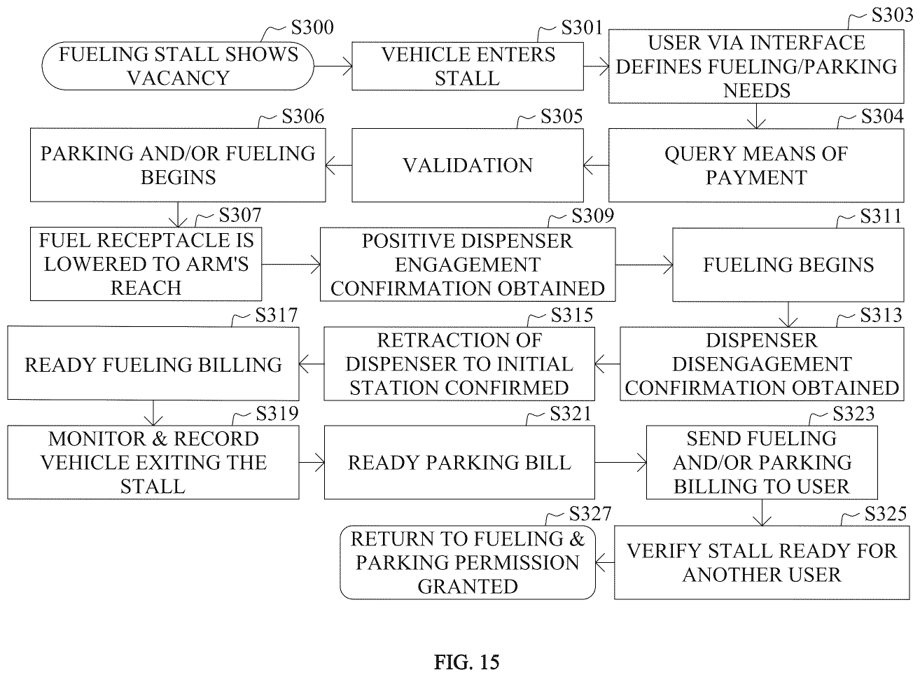

FIG. 15 shows a process diagram for fueling a vehicle wherein the vehicle/user obtains fueling authorization through an interface parked in fueling parking stall. The process begins in step S300 where the processor recognizes the fueling stall shows a vacancy. The processor may determine this in a variety of ways, but in this example it determines it from an image recognition process performed in the stall, and sends a message to the processor indicating the stall is empty. The process then proceeds to step S301 where the vehicle enters the stall, and then in step S303 the user interface defines fueling parking needs for the vehicle that is in the stall. The needs are set by user selection, and or sensor outputs from the vehicle (e.g., low diesel fuel level at 10% of capacity). The process then proceeds to step S304 where the processor prompts a user device for mean of payment. This is an optional step, as it in some embodiments the physical connection of the dispenser to the vehicle's fuel receptacle triggers a pre-registered means of payment (e.g., pre-saved credit card or payment account, such as PAYPAL). The process then proceeds to step S305 where the payment is validated.

The process then proceeds to step S306 where the parking and/or fueling event commences. The process then proceeds to step S307 where the fuel dispenser is lowered to an arm's reach (e.g., from 3′ through 7′). The fuel dispenser is terminated with a nozzle, connector, or gas fitting at the end of tubing or a cable. The cable/hose terminal is mechanically configured to be received by the vehicle's fueling receptacle. In the case of a gasoline powered vehicle, a nozzle provides at least one of gasoline or diesel fuel to the vehicle. Alternatively, the vehicle may be detected as being fueled by a different type of fuel, such as hydrogen or electricity. If the fuel is hydrogen, the terminal at the end of the fueling receptacle is one of a gas fitting that is configured to dispense a gaseous form of hydrogen or an interlocking terminal that conveys a liquid form of hydrogen there through. The hydrogen is controlled to flow after confirmation of a mechanical attachment to the vehicle's fuel receptacle and a sensor detects a successful attachment and seal, which then triggers the controlling processor to release a controlled amount of hydrogen to the vehicle. Electrical fueling operates in a similar manner, although a different connector that is compatible to the charging receptacle on the vehicle is used by the overhead fueling system to provide electricity to charge the vehicle via the vehicles charging receptacle. For inductive charging with an underlying charging coil, charging may commence once proper alignment with the vehicle's pick-up coil(s) is confirmed.

In the case of mechanical engagement of the dispenser with the vehicle's receptacle, once successful attachment of the dispenser is recognized in step S309, and subsequently once the engagement is determined, fueling begins in step S311. Subsequently, the dispenser is disengaged from the vehicle's fuel receptacle and confirmation of the same is obtained in step S313. Subsequently the process proceeds to step S315 where the dispenser is retracted.

The process then proceeds to step S317 where billing for the fueling operation is prepared. The fuel bill is conveyed in a digital message to a computer-based service for which the user of the vehicle has an account (step S319). Moreover, monitoring and recording of the vehicle's fueling experience in the stall prior to the exiting of the vehicle from the stall is performed at this stage. The process then proceeds to step S321, where a message is dispatched from the processor regarding the a parking bill for the time the vehicle was located in the stall. Subsequently the process proceeds to step S323 where the fueling and parking bills (invoices) are provided to another electronic device that processes the payment and invoices the user. The process then proceeds the step S325 where verification is performed of the stall being available for another vehicle. This may be performed by visual detection by an overhead camera that takes an image and verifies that the stall is empty. Subsequently, the process proceeds to step S327 where the process repeats in steps 200 for another vehicle.

FIG. 16 is a diagram of a more detailed diagram of electronic based components, including a programmable processor (“circuitry”) that serves to control processes of the various embodiments described herein. The control and sensor portions of the present disclosure may be embodied as a system, a method, and/or a computer program product. The computer program product may include a computer readable storage medium on which computer readable program instructions are recorded that may cause one or more processors to carry out aspects of the embodiment.

The computer readable storage medium may be a tangible device that can store instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the computer readable storage medium includes each of the following (and appropriate combinations): flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer readable program instructions may execute entirely on a user's personal computer, notebook computer, tablet, or smartphone, entirely on a remote computer or computer server, or any combination of these computing devices. The remote computer or computer server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

Aspects of the present disclosure are described herein with reference to flow diagrams and block diagrams of methods, apparatus (systems), and computer program products according to embodiments of the disclosure. It will be understood by those skilled in the art that each block of the flow diagrams and block diagrams, and combinations of blocks in the flow diagrams and block diagrams, can be implemented by computer readable program instructions.

The computer readable program instructions that may implement the systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

FIG. 16 is a functional block diagram illustrating a networked system 800 of one or more networked computers and servers. In an embodiment, the hardware and software environment illustrated in FIG. 16 may provide an exemplary platform for implementation of the software and/or methods according to the present disclosure.

Referring to FIG. 16, a networked system 800 may include, but is not limited to, computer 805, network 810, remote computer 815, web server 820, cloud storage server 825 and computer server 830. In some embodiments, multiple instances of one or more of the functional blocks illustrated in FIG. 16 may be employed.

Additional detail of computer 805 is shown in FIG. 16. The functional blocks illustrated within computer 805 are provided only to establish exemplary functionality and are not intended to be exhaustive. And while details are not provided for remote computer 815, web server 820, cloud storage server 825 and computer server 830, these other computers and devices may include similar functionality to that shown for computer 805.

Computer 805 may be a personal computer (PC), a desktop computer, laptop computer, tablet computer, netbook computer, a personal digital assistant (PDA), a smart phone, or any other programmable electronic device capable of communicating with other devices on network 810.

Computer 805 may include processor 835, bus 837, memory 840, non-volatile storage 845, network interface 850, peripheral interface 855 and display interface 865. Each of these functions may be implemented, in some embodiments, as individual electronic subsystems (integrated circuit chip or combination of chips and associated devices), or, in other embodiments, some combination of functions may be implemented on a single chip (sometimes called a system on chip or SoC).

Processor 835 may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

Bus 837 may be a proprietary or industry standard high-speed parallel or serial peripheral interconnect bus, such as ISA, PCI, PCI Express (PCI-e), AGP, and the like.

Memory 840 and non-volatile storage 845 may be computer-readable storage media. Memory 840 may include any suitable volatile storage devices such as Dynamic Random Access Memory (DRAM) and Static Random Access Memory (SRAM). Non-volatile storage 845 may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

Program 848 may be a collection of machine readable instructions and/or data that is stored in non-volatile storage 845 and is used to create, manage and control certain software functions that are discussed in detail elsewhere in the present disclosure and illustrated in the drawings. In some embodiments, memory 840 may be considerably faster than non-volatile storage 845. In such embodiments, program 848 may be transferred from non-volatile storage 845 to memory 840 prior to execution by processor 835.

Computer 805 may be capable of communicating and interacting with other computers via network 810 through network interface 850. Network 810 may be, for example, a local area network (LAN), a wide area network (WAN) such as the Internet, or a combination of the two, and may include wired, wireless, or fiber optic connections. In general, network 810 can be any combination of connections and protocols that support communications between two or more computers and related devices.

Peripheral interface 855 may allow for input and output of data with other devices that may be connected locally with computer 805. For example, peripheral interface 855 may provide a connection to external devices 860. External devices 860 may include, for example, (1) user interface devices such as a keyboard, a mouse, a keypad, a touch screen, or input devices, (2) portable computer-readable storage media such as, for example, thumb drives, portable optical or magnetic disks, and memory cards, and (3) sensors, including temperature, pressure, fluid PH, and light sensors. Software and data used to practice embodiments of the present disclosure, for example, program 848, may be stored on such portable computer-readable storage media. In such embodiments, software may be loaded onto non-volatile storage 845 or, alternatively, directly into memory 840 via peripheral interface 855. Peripheral interface 855 may use an industry standard connection, such as RS-232 or Universal Serial Bus (USB), to connect with external devices 860.

Display interface 865 may connect computer 805 to display 870. Display 870 may be used, in some embodiments, to present a command line or graphical user interface to a user of computer 805. Display interface 865 may connect to display 870 using one or more proprietary or industry standard connections, such as VGA, DVI, DisplayPort and HDMI.

As described above, network interface 850, provides for communications with other computing and storage systems or devices external to computer 805. Software programs and data discussed herein may be downloaded from, for example, remote computer 815, web server 820, cloud storage server 825 and computer server 830 to non-volatile storage 845 through network interface 850 and network 810. Furthermore, the systems and methods described in this disclosure may be executed by one or more computers connected to computer 805 through network interface 850 and network 810. For example, in some embodiments the systems and methods described in this disclosure may be executed by remote computer 815, computer server 830, or a combination of the interconnected computers on network 810.

Power Supply 930 not only provides power for computer 805 but also optionally provides a power source for external devices 860. The power supply 930 may be implemented to draw power from an AC mains when the device is physically connected to an outlet. In this case, the power supply 930 may include an AC/DC converter that provides DC output for external devices, as well as to store charge in a rechargeable battery and/or capacitor. Alternatively, or additionally, the power supply 930 may receive a DC input, such as via a USB port. In this configuration the power supply 930 may provide DC power of various output voltages to external devices as well as AC power provided via a pulse code modulation-based DC to AC inverter.

Wireless transceiver 950 includes a radio frequency (RF) receiver and a RF transmitter that cooperate, under control of the processor 935 to exchange wireless communication signals with external devices. Non-limiting examples of the wireless communications may be local RF communications, such as by BLUETOOTH or WiFi, or cellular transmission such as via 5G.

Data, datasets and/or databases employed in embodiments of the systems and methods described in this disclosure may be stored and or downloaded from remote computer 815, web server 820, cloud storage server 825 and computer server 830.

With reference to FIGS. 17-19, processes, and computer architectures for implementing various AI engines discussed herein by using as an example of particular trained AI engines that visually detect a vehicle and a type of fuel for that vehicle. Therefore, how a computing device a vehicle and type of fuel used by that vehicle, will be explained. However, it should be understood that other AI engines may be trained, in a similar manner, to implement or assist various parking manager detection and control operations, such as
1. detection of human or animal behavior in a stall that is indicative of an anticipated violent or dangerous action so preventive action may be taken (e.g., control the fuel dispenser to cease operation and trigger a warning),
2. The location and functionality of each sensing, input, and output device within the fueling parking stall and remote parking manager and/or associated device
3. Size, color, shape, and specifications of all moving objects capable of being fueled
4. Recognition of specific formats of alphanumeric characters and/or symbols
5. Recognition of changes in the environment due to seasonal changes such as icing, ponding, leaf scattering and other debris
6. Recognition of humans and animals by form and body language
7. Recognition of sound including human voice recognition and ability to interact vocally
8. Ability to improve on friendly interaction with a vehicle processor, handheld device, and an exterior mounted interface through at least a feed-back loop
9. Recognition of threats to humans, animals, and/or property

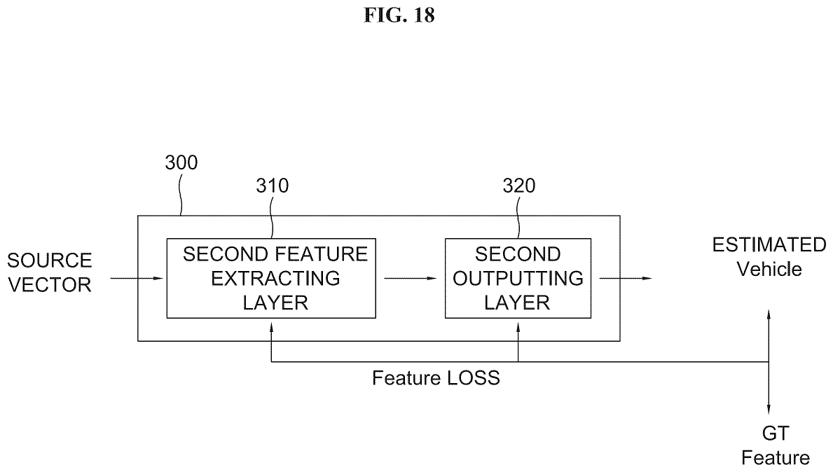

A configuration of a computing device that implements an AI engine is described with respect to a computing device that includes a data extraction network 200 (FIG. 17) and a data analysis network 300 (FIG. 18). Further, the data extraction network 200 includes at least one first feature extracting layer 210, at least one Region-Of-Interest (ROI) pooling layer 220, at least one first outputting layer 230 and at least one data vectorizing layer 240. And, as illustrated in FIG. 18, the data analysis network 300 includes at least one second feature extracting layer 310 and at least one second outputting layer 320.

Below, specific processes of estimating a vehicle type, and a type of fuel used in that vehicle will be explained. To begin with, a first embodiment of the AI engine is presented. First, the computing device acquires at least one subject image (e.g, an image of a scene that includes at least one vehicle). The subject image may correspond to a scene of a road, photographed from an elevated position (e.g., traffic camera), including a portion of the vehicle that includes an indication of a location of a fuel receptacle for that vehicle (e.g., a hinged cover for the fuel receptacle).

After the subject image is acquired, in order to generate a source vector to be inputted to the data analysis network 300, the computing device (in this example the processing system, or “circuitry” of FIG. 16) may instruct the data extraction network 200 to generate the source vector including (i) an apparent vehicle model, which has an associated location of the fuel receptacle, and (ii) an apparent fuel type, such as gasoline, electric, or hydrogen. It should be noted that different vehicle models may have different fuel types, such as gas powered, hybrid, all-electric, plug-in hybrid (with gas and electrical receptacles), as well as hydrogen.

In order to generate the source vector, the computing device may instruct at least part of the data extraction network 200 to detect the vehicle type and fuel type.

Specifically, the computing device instructs the first feature extracting layer 210 to apply at least one first convolutional operation to the subject image, to thereby generate at least one subject feature map. Thereafter, the computing device may instruct the ROI pooling layer 220 to generate one or more ROI-Pooled feature maps by pooling regions on the subject feature map, corresponding to ROIs on the subject image which have been acquired from a Region Proposal Network (RPN) interworking with the data extraction network 200. And, the computing device may instruct the first outputting layer 230 to generate at least one estimated vehicle type and at least one estimated fuel type (“Feature 2”). That is, the first outputting layer 230 may perform a classification and a regression on the subject image, by applying at least one first Fully-Connected (FC) operation to the ROI-Pooled feature maps, to generate each of the estimated vehicle type (model) and the estimated fuel type for that model vehicle, including information on coordinates of each of bounding boxes. Herein, the bounding boxes may include the vehicle itself, as well indicia about the vehicle such model names, and the fuel receptacle(s).

After such detecting processes are completed, by using the estimated vehicle type and the estimated fuel type, the computing device 100 may instruct the data vectorizing layer 240 to compare the estimated model to candidate models to generate the apparent model and apparent fuel type.

After the apparent model and the apparent fuel type are acquired, the computing device may instruct the data vectorizing layer 240 to generate at least one source vector including the apparent model and the apparent fuel type as its at least part of components.

Then, the computing device 100 may instruct the data analysis network 300 to calculate an estimated model by using the source vector. Herein, the second feature extracting layer 310 of the data analysis network 300 may apply second convolutional operation to the source vector to generate at least one source feature map, and the second outputting layer 320 of the data analysis network 300 may perform a regression, by applying at least one FC operation to the source feature map, to thereby calculate the estimated feature 2, which in this example is fuel type.

As shown above, the computing device may include two neural networks, i.e., the data extraction network 200 and the data analysis network 300. The two neural networks are shown as convolutional neural networks (CNN), but could also be graph neural networks (GNN), and the CNNs in this example, should be trained to perform said processes properly. Below, how to train the two neural networks will be explained.

First, by referring to FIG. 17, the data extraction network 200 may have been trained by using (i) a plurality of training images corresponding to scenes of subject vehicles in various scenarios (e.g., driveways, overhead images, advertisement images from the Internet, etc.) for training, where the training images include images from differing perspectives and differing contexts, including partially masked vehicles, and vehicles will various add-on decorations (e.g., pizza delivery signage, advertisement wraps, non-factory paint), and (ii) a plurality of their corresponding GT (ground truth) images (base images of the actual vehicle types) and GT images of a feature, such as fuel type for that vehicle.

More specifically, the data extraction network 200 may have applied aforementioned operations to the training images, and have generated their corresponding estimated vehicle type and estimated fuel type. Then, (i) each of ground pairs of each of the estimated vehicle type and each of their corresponding GTs and (ii) each of fuel type of each of the estimated vehicle types and each of the GT fuel types, in order to generate at least one “vehicle loss” and at least one “feature 2 loss”, by using any of loss generating algorithms, e.g., a smooth-L1 loss algorithm and a cross-entropy loss algorithm. Thereafter, by referring to the vehicle loss and the feature 2 loss, backpropagation is performed to learn at least part of parameters of the data extraction network 200. Parameters of the RPN can be trained also, but a usage of the RPN is known, and thus further explanation of the RPN parameters is omitted.

Herein, the data vectorizing layer 240 may have been implemented by using a rule-based algorithm, not a neural network algorithm. In this case, the data vectorizing layer 240 may not need to be trained, and may just be able to perform properly by using its settings inputted by a manager. In one example, the data vectorization layer may be implemented with data from an image recognition system that uses pixel matching to detect a vehicle or fuel type for a vehicle. Moreover, as an example, the first feature extracting layer 210, the ROI pooling layer 220 and the first outputting layer 230 may be acquired by applying a transfer learning, which is known, to an existing object detection network such as VGG or ResNet, etc.

Second, by referring to FIG. 18 the data analysis network 300 may have been trained by using (i) a plurality of source vectors for training, including apparent vehicle types and fuel types for training as their components, and (ii) a plurality of their corresponding GT fuel types. More specifically, the data analysis network 300 may have applied aforementioned operations to the source vectors for training, to thereby calculate their corresponding estimated fuel types for training. Then each of fuel type pairs of each of the estimated fuel type and each of their corresponding GT fuel types may have been referred to, in order to generate at least one feature loss, by using said any of loss algorithms. Thereafter, by referring to the feature loss, backpropagation can be performed to learn at least part of parameters of the data analysis network 300.

After performing such training processes, the computing device 100 can properly calculate the estimated fuel type by using the subject image including a scene containing the vehicle and indicia of a type of fuel used in that vehicle.

Hereafter, another embodiments will be presented.

As another embodiment, the source vector may further include an actual distance, which is a distance in a real world between the camera and the vehicle or portion of the vehicle indicating the fuel type, as an additional component of the source vector. For the third embodiment, it is assumed that a camera height, which is a distance between the camera and a ground directly below the camera in the real world, is provided.

The computing device may instruct the data analysis network 300 to calculate the actual distance by referring to information on the camera height, the tilt angle, a coordinate of the lower boundary of the vehicle, by using a following formula:

$${d}_{actual} = \sqrt{\frac{{h}^{2} + {h}^{2} {tan}^{2} \{ \frac{π}{2} + {θ}_{tilt} - a tan ( \frac{y - c y}{f y} ) \}}{1 + \frac{{( y - c y )}^{2}}{f {y}^{2}}} {( \frac{x - c x}{f x} )}^{2} + {h}^{2} {tan}^{2} \{ \frac{π}{2} + {θ}_{tilt} - ( \frac{y - c y}{f y} ) \}}$$

In the formula, x and y may denote coordinates of the lower boundary of the vehicle, fx and fy may denote the focal lengths for each axis, cx and cy may denote coordinates of the principal point, and h may denote the camera height. A usage of such formula for calculating the actual distance is known, thus further explanation is omitted.

After the actual distance is calculated, the data vectorizing layer 240 may set the actual distance as the additional component of the source vector, and the data analysis network 300 may use such source vector to calculate the estimated vehicle type, which helps to normalize the perspective of the image of the subject vehicle in the scene with respect to the vehicle in the ground truth image. Also, in this case, the data analysis network 300 may have been trained by using the source vectors for training additionally including actual distances for training.

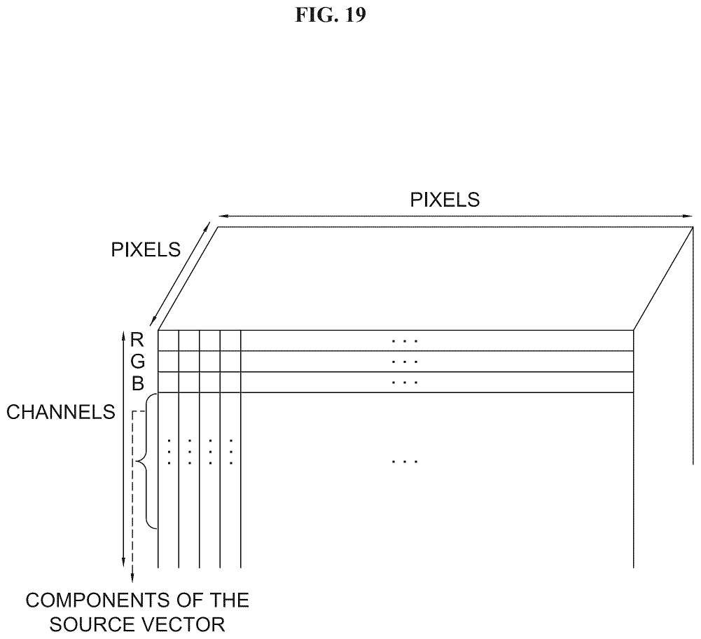

As another embodiment, the source vector, generated by using any of the above embodiments, can be concatenated channel-wise to the subject image or its corresponding subject segmented feature map, which has been generated by applying an image segmentation operation thereto, to thereby generate a concatenated source feature map, and the data analysis network 300 may use the concatenated source feature map to calculate the estimated vehicle and fuel type. An example configuration of the concatenated source feature map may be shown in FIG. 19. In this case, the data analysis network 300 may have been trained by using a plurality of concatenated source feature maps for training including the source vectors for training, other than using only the source vectors for training. By using this embodiment, much more information can be inputted to processes of calculating the estimated fuel type for that vehicle, thus it can be more accurate. Herein, if the subject image is used directly for generating the concatenated source feature map, it may require too much computing resources, thus the subject segmented feature map may be used for reducing a usage of the computing resources.

Obviously, numerous modifications and variations of the present disclosure are possible in light of the above teachings. It is therefore to be understood that within the scope of the appended claims, the disclosure may be practiced otherwise than as specifically described herein.

1. An overhead fueling system for a universal fuel source comprising:
an overhead parking system module having
a post in or adjacent to a fueling parking stall,
a beam is coupled to the post from above, the beam having a fuel charger coupled thereto, and
programmable circuitry programmed to implement a parking manager communicatively coupled to the fuel charger, the parking manager comprising a processor, resident memory and computer code that is executable by the processor, the programmable circuitry having a digital communication capability, wherein
a fuel conductor coupled to the beam conveys fuel to the fuel charger and extends at least a portion of a full length of the beam, fuel is conveyable to the conductor from another conductor from an overhead remote source,
the parking manager is configured to direct the fuel charger to convey fuel to a vehicle parked in the fueling parking stall by at least one of a fuel dispenser coupled to or in proximity to the beam and/or an induction coil embedded in the fueling parking stall pavement, and
a transverse cross-section area of the post is sufficient in structure to support erection of the overhead parking system module over the fueling parking stall without expanding a footprint of a predetermined parking stall dimension.

2. The overhead fueling system of claim 1, comprising the induction coil, the induction coil is communicatively coupled to the parking manager and inductively coupled to a vehicle during charging of the vehicle.

3. The overhead fueling system of claim 1, wherein at eye level, a horizontal visual obstruction is limited to a width of a post with or without a protective guard placed thereon.

4. The overhead fueling system of claim 1, further comprising an interface panel coupled to the post to facilitate communication between a user and the parking manager.

5. The overhead fueling system of claim 1, wherein the fuel dispenser is configured to have vertical, or lateral and vertical mobility.

6. The overhead fueling system of claim 1, further comprising a canopy coupled to the beam to provide shade and/or generates fuel.

7. The overhead fueling system of claim 6, further comprising a fuel generating device coupled to the canopy or the beam that provides a source of fuel for refueling a vehicle.

8. The overhead fueling system of claim 1, wherein the fuel conductor conveys at least one of: electricity, fluid, and/or gas.

9. The overhead fueling system of claim 1, wherein the beam is configured to convey therethrough more than one type of fuel.

10. The overhead fueling system of claim 1, wherein at least one of a fuel storage device, a switching device, a surge suppressor, a lightning arrester, an illuminated sign, a light source, an audio device, a camera, and an air quality sensor is coupled to the beam.

11. The overhead fueling system of claim 1, wherein execution of the computer code by the parking manager implements an AI engine.

12. The overhead fueling system of claim 11, wherein the AI engine is self-learns how to improve serviceability performance of the overhead fueling system over time.

13. An overhead modular fuel dispensing system comprising:
an overhead parking system module having
a post in or adjacent to a fueling parking stall,
a beam is coupled to the post from above, the beam having a fuel charger coupled thereto, and
programmable circuitry programmed to implement a parking manager communicatively coupled to the fuel charger, the parking manager comprising a processor, resident memory and computer code that is executable by the processor, the programmable circuitry having a digital communication capability that communicates with at least one of a vehicle, a handheld device, and/or a communication transceiver having an interface exterior to the vehicle,
the processor communicates in real time with at least one sensor and
a remote processor, and
the processor is configured to grant permission for a vehicle to execute at least one of enter a fueling parking stall, fuel a vehicle, and receive a bill for using the fueling parking stall.

14. The overhead modular fuel dispensing system of claim 13, wherein the parking manager is configured to alert at least one of a user, a facility operator, and/or a remote party when an anomaly is sensed.

15. The overhead modular fuel dispensing system of claim 13, wherein the parking manager is configured to adaptively improve performance by learning from events occurring during vehicle refueling operations in the fueling parking stall.

16. The overhead modular fuel dispensing system of claim 13, wherein the parking manager is configured to communicate with at least one adjacent parking manager.

17. The overhead modular fuel dispensing system of claim 13, wherein the parking manager is configured to receive an process a sensory input from a digitally mapped fueling parking stall.

18. The overhead modular fuel dispensing system of claim 13, wherein the parking manager is configured to perform image recognition of objects in the fueling parking stall to monitor for anomalies with respect to a reference image.

19. The overhead modular fuel dispensing system of claim 13, wherein further comprising an output device including a sign and/or an audio device coupled to the beam or a canopy.

20. A computer-implemented method for fueling a vehicle from an overhead system, the method comprising:
detecting with a sensor whether a fueling stall is vacant;
in response to a request message associated with a particular vehicle, providing access to the fueling stall for the particular vehicle, and identifying a type of fuel associated with the vehicle;
authorizing refueling of the vehicle with the type of fuel associated with the vehicle in response to confirming a source of payment;
dispatching a fuel dispenser from above to a first height aligned that enables the fuel receptacle to be engaged with a fueling port of the particular vehicle;
engaging the fuel dispenser from the with the fuel receptacle, and begin refueling;
monitoring an amount of fuel to be imparted to the particular vehicle and stop refueling once the amount of fuel is reached;
disengaging the fuel dispenser from the fuel receptacle;
billing an account associated with the particular vehicle; and
retracting the fuel dispenser to a second height that is higher than the first height.
